(19) United States
(12) Patent Application Publication
(10) Pub. No.: US 2024/0410442 A1
(43) Pub. Date: Dec. 12, 2024

(54) Vibration Damping of Structures Using Slip in Pretensioned Coils

(71) Applicant: California Institute of Technology, Pasadena, CA (US)

(72) Inventors: Sergio Pellegrino, Pasadena, CA (US); Alexander Wen, South Pasadena, CA (US)

(73) Assignee: California Institute of Technology, Pasadena, CA (US)

(21) Appl. No.: 18/737,918

(22) Filed: Jun. 7, 2024

Related U.S. Application Data
(60) Provisional application No. 63/471,541, filed on Jun. 7, 2023.

(51) Int. Cl. F16F 15/121; F16F 1/10

(52) U.S. Cl. CPC F16F 15/1213; F16F 1/10

(57) ABSTRACT

Systems and devices for dynamic damping of vibrations are described. Traditional methods of vibration damping often involve trade-offs between stiffness and damping, potentially compromising structural integrity for increased damping. The performance of these damping techniques can also be influenced by the specific profile of the vibrational excitation, presenting challenges in ensuring consistent and reliable damping across different operating conditions. A tunable friction-damping device formed from concentric layers can overcome many of these limitations and presents methods for dynamic damping of vibrations as an alternative solution.

### CROSS-REFERENCE TO RELATED APPLICATIONS

This application claims priority to U.S. Provisional Patent Application No. 63/471,541, filed Jun. 7, 2023, the disclosure of which is incorporated herein by reference.

### FIELD OF THE INVENTION

This application generally relates to structural damping. More specifically, this application relates to tensioned coil damping devices and systems and methods of their use.

### BACKGROUND

Structures are constantly subjected to various forms of vibration, and it's crucial to manage these vibrations to ensure the survival and longevity of the structures. The way a structure responds to vibration is influenced by the complex interplay between the external forces causing the vibration and the inherent properties of the structure itself. When it's not feasible to control the external forces causing the vibration, the focus shifts to engineering the structure in a way that enables it to withstand the effects of the vibrations.

One effective strategy for reducing the vibrational response of structures involves the implementation of damping. Damping is a technique that involves the incorporation of specialized devices or materials into the structure to dissipate kinetic energy as heat. By doing so, the overall energy within the system is reduced, leading to a decrease in the amplitude of the vibrational response. There are numerous established concepts and techniques for vibration damping, each with its own unique characteristics and applications.

However, traditional methods of vibration damping are not without their limitations. For instance, some approaches may involve a tradeoff between stiffness and damping, potentially compromising the structural integrity for the sake of increased damping. Additionally, the performance of these damping techniques can be influenced by the specific profile of the vibrational excitation, presenting challenges in ensuring consistent and reliable damping across different operating conditions. Therefore, it is important to identify and implement new and alternative methods of damping to increase the survivability of structures, limit design constraints, and enable the adoption and use of damping devices in more structures.

### SUMMARY OF THE INVENTION

Devices and methods in accordance with some embodiments of the invention are directed to the damping device, their structure methods for their manufacture and use.

Many embodiments of the disclosure are directed to a device for dynamic damping of vibrations comprising, a plurality or layers disposed adjacently to define a plurality of layer interfaces, the plurality of layers configured to generate a friction force between the plurality of layer interfaces; and a load force applied to the plurality of layers, across the plurality of layer interfaces and configured to permit an interlayer slip between the plurality of layers during a vibrational excitation, such that a vibrational excitation force applied to the device induces the interlayer slip and a frictional force thereby reducing the amount of the vibrational excitation; wherein the plurality of layers form a concentric structure, and each of the plurality of layer interfaces is configured to have a coefficient of friction and to be disposed such that there are one or more points of contact between adjacent layer interfaces.

In numerous embodiments, the concentric structure is configured in a spiral geometry.

In various embodiments, a first layer with a first layer interface and a second layer interface is configured such that the first layer interface contacts the second layer interface.

In several embodiments the device further comprises a spindle element, and wherein at least one layer is coupled to the spindle element.

In many embodiments, a tension force is applied to the plurality of layers.

In numerous embodiments, the tension force applies a radial load to the concentric structure to generate an additional frictional force thereby adjusting the interlayer slip.

In various embodiments, the plurality of layers further comprise at least one sacrificial layer configured to abrade under the interlayer slip.

In several embodiments, a compositional discontinuity is disposed within at least one of the plurality of layers.

In many embodiments, at least one of the plurality of layers further comprises a void.

In numerous embodiments, the plurality of layers are disposed such that the plurality of interfaces are not contiguous.

In various embodiments, the at least one layer has a thickness that is nonuniform and such that there is intermittent contact between the layer interfaces of at least one layer adjacent thereto.

In several embodiments, the concentric structure has a resonant frequency, and wherein the preload force is configured based on the resonant frequency.

In many embodiments, the tension force is further configured to adjust the stiffness of the concentric structure.

In numerous embodiments, the plurality of layers are further configured to induce a propagation of the interlayer slip to additional layers under the vibrational excitation.

In various embodiments, the plurality of layers form concentric circles such that each layer has at least one layer interface in contact with at least one layer interface of an adjacent layer.

Various embodiments of the disclosure are directed to, a method of dynamic vibration damping comprising, providing a load force to tune a structure, wherein the structure comprises a plurality of concentric layers disposed adjacent to define a plurality of layer interfaces, the plurality of layers configured to allow interlayer slip therebetween and generate a frictional force between the plurality of layer interfaces, inducing an interlayer slip between the plurality of layers via application of a vibrational excitation force to the structure such that a frictional force is further induced at the adjacent interfaces, thereby reducing the propagation of the excitation force, wherein each of the plurality of layer interfaces is configured to have a coefficient of friction and is disposed such that there are one or more points of contact between adjacent layer interfaces, and wherein varying the load force provided alters the frictional force and the interlayer slip thereby varying at least one of the energy dissipation, stiffness, and damping properties of the structure.

In many embodiments, the damping and stiffness of the structure are further tunable by configuring the points of contact and the coefficient of friction, and where the interlayer slip only occurs across a partial region of at least one of the layer interfaces.

In numerous embodiments, the damping of the structure is further tunable by configuring the interlayer slip such that at a set vibrational excitation, the interlayer slip propagates across a set number of the plurality of layers.

In various embodiments, the structure has a resonant frequency, and wherein the load force is set based on the resonant frequency.

In several embodiments, the concentric layers form a spiral structure, and wherein a winding tension is applied to the spiral structure, thereby changing the frictional force in the structure and such that the damping of the structure is further tunable.

Numerous embodiments of the disclosure are directed to an energy absorbing structure comprising, a structure defining a volume the structure comprising at least one multilayer element comprised of a plurality of concentric layers configured with adjacent interfaces wherein an excitation force applied to the structure induces an interlayer slip between the adjacent interfaces of the multilayer element; wherein the adjacent interfaces are configured to generate a frictional force during the interlayer slip and thereby reduce the excitation force within the structure; and wherein the frictional force is configurable by applying a selected preload force and a selected stress to the structure.

In numerous embodiments, the damping and stiffness of the structure are further tunable by configuring the plurality of layer interfaces such that the interlayer slip only occurs across a partial region of the plurality of layer interfaces.

In various embodiments, the structure is disposed within a vehicle, and the volume is configured to receive a payload.

Some embodiments of the disclosure are directed to a device for dynamic damping of vibrations comprising,
a concentrically wound layer configured to form a spiral structure and generate a set friction force between a plurality of layer interfaces; and a load force applied to the concentrically wound layer, across the plurality of layer interfaces and configured to permit an interfacial slip between the plurality of layer interfaces during a vibrational excitation, thereby inducing a frictional force therebetween reducing the amount of the vibrational excitation; wherein each of the plurality of layer interfaces are configured to have a coefficient of friction and are disposed such that there are one or more points of contact between each adjacent layer interface.

In many embodiments the device further comprises a spindle element, wherein the concentrically wound layer is coupled to the spindle element.

In numerous embodiments, a compositional discontinuity is disposed within the concentrically wound layer.

In various embodiments, the concentrically wound layer further comprises a void.

In several embodiments, the concentrically wound layer is disposed such that the plurality of interfaces are not contiguous.

In many embodiments, the concentrically wound layer has a thickness that is nonuniform and such that there is intermittent contact between the layer interfaces adjacent thereto.

In numerous embodiments, the spiral structure has a resonant frequency, and wherein the load force is set based on the resonant frequency.

In various embodiments, the concentrically wound layer is further configured to induce a propagation of the interfacial slip through the plurality of layer interfaces under the vibrational excitation.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as embodiments of the invention and should not be construed as a complete recitation of the scope of the invention, wherein:

FIGS. 1A through 1B depict vibration mitigation of a 1-DoF mass-spring-damper system in accordance with prior art.

FIGS. 2A through 2C illustrate various coiled space deployable structures in accordance with prior art.

FIG. 3 illustrates a schematic of coiling as a packaging architecture in accordance with prior art.

FIGS. 4A and 4B depict slipping deformation due to dynamic loading in accordance with prior art.

FIG. 5 illustrates a schematic of the wound roll damping device in accordance with some embodiments.

FIG. 6 shows the geometry of the winding problem model.

FIG. 7 shows a comparison between a soft roll vs. a hard roll.

FIG. 8 illustrates the deformation directions for a wound roll in accordance with an exemplary embodiment.

FIG. 9 depicts a wound roll configuration attached to a cantilevered mandrel, with tip mass, subjected to base excitation in accordance with an exemplary embodiment.

FIG. 10 illustrates wound roll vibration as a cantilever beam subjected to uniform load and tip load in accordance with an exemplary embodiment.

FIG. 11 depicts shear and moment diagrams for a cantilever beam in accordance with an exemplary embodiment.

FIG. 12 illustrates the Locations of the highest stresses for beam-bending in accordance with an exemplary embodiment.

FIG. 13 depicts Representative Volume Element (RVE) pictured containing carbon fiber elements and Kapton membrane in accordance with an exemplary embodiment.

FIG. 14 depicts Coiled Structure Geometry in accordance with an exemplary embodiment.

FIG. 15 depicts the shear capacity as a function of the radial position in accordance with an exemplary embodiment.

FIG. 16 depicts variation in bending mode resonant frequency with effective shear stiffness of coil in accordance with an exemplary embodiment.

FIGS. 17A and 17B depict shear resultant histograms by location in the coil under varying excitation levels.

FIGS. 18A and 18B depict contour plots of stress components at the bottom cross-section of the coil due to 15 g sinusoidal loading in accordance with an exemplary embodiment.

FIG. 19 depicts the expected wound roll resonant frequency disparity with mandrel radius and wall thickness for polycarbonate mandrels in accordance with an exemplary embodiment.

FIG. 20 depicts variation in stiffness with shear stiffness in accordance with an exemplary embodiment.

FIG. 21 depicts mandrel components, construction, and dimensions, in accordance with an exemplary embodiment.

FIG. 22 depicts a constant tension winding machine.

FIG. 23 depicts a Kapton winding start/termination scheme:

FIG. 24 depicts a wound roll damper test sample, in accordance with an exemplary embodiment.

FIG. 25 depicts measured winding tension variation with winding motor voltage (winding speed) and membrane roller current, in accordance with an exemplary embodiment.

FIG. 26 depicts a vibration experiment of a wound roll, in accordance with an exemplary embodiment.

FIG. 27 depicts the maximum sweep rate, normalized by natural frequency, for 1-DoF, in accordance with an exemplary embodiment.

FIG. 28 depicts damping from transmissibility, in accordance with an exemplary embodiment.

FIG. 29 depicts resonant frequency variation of wound roll, in accordance with an exemplary embodiment.

FIGS. 30A and 30B depict wound roll damper frequency response and damping variation, in accordance with an exemplary embodiment.

FIGS. 31A through 31C depicts variation in transmissibility with excitation amplitude for random vibration of the wound roll under different winding tensions, in accordance with an exemplary embodiment.

FIG. 32 depict wound roll damping variation with excitation amplitude and winding tension, in accordance with an exemplary embodiment.

FIG. 33 depicts shock time series used to convert into voltage time series input into vibration table, in accordance with an exemplary embodiment.

FIG. 34 depicts wound roll damper shock response time domain data, in accordance with an exemplary embodiment.

FIG. 35 depicts extracted peak acceleration variation with winding tension from shock response, in accordance with an exemplary embodiment.

FIG. 36 depicts slip measurement location and direction conventions, in accordance with an exemplary embodiment.

FIGS. 37A and 37B depict noise floor estimation of measurement and centroid tracking processing chain, in accordance with an exemplary embodiment.

FIG. 38 depicts aggregate mandrel relative slip, in accordance with an exemplary embodiment.

FIGS. 39A and 39B depict a comparison between axially measured, vertical slip relative to the mandrel for tight and loose winding, in accordance with an exemplary embodiment.

FIG. 40 depicts interlayer slip, relative to layer 6, for axially measured, vertical slip for loose winding in accordance with an exemplary embodiment.

FIG. 41 depicts geometry of coiled structure for FEA, in accordance with an exemplary embodiment.

FIG. 42 depicts penalty friction model compared against Coulomb friction model.

FIG. 43 depicts mapping of winding tension to radial preload, calculated from winding stress models, in accordance with an exemplary embodiment.

FIGS. 44A and 44B depict a comparison between simulated and experimentally measured frequency responses, in accordance with an exemplary embodiment.

FIG. 45 depicts damping-resonant frequency variation with preload; comparison between simulation (diamonds) and experiment (circles), in accordance with an exemplary embodiment.

FIGS. 46A and 46B depict tip response and frictional energy dissipation from FEA sine sweep for low and high preload cases, in accordance with an exemplary embodiment.

FIG. 47 depicts frictional energy dissipation, from lab-scale FEA simulation vs. radial preload, in accordance with an exemplary embodiment.

FIG. 48 depicts frictional energy dissipation, vs. damping, in accordance with an exemplary embodiment.

FIGS. 49A and 49B depict different boundary conditions (between experiment and simulation, in accordance with an exemplary embodiment.

FIG. 50 depicts cumulative locations of slip with loading variation, in accordance with an exemplary embodiment.

FIG. 51 depicts maximum relative displacement vectors between adjacent layers for 1g loading, in accordance with an exemplary embodiment.

### DETAILED DESCRIPTION OF THE INVENTION

It's crucial to manage vibrations for the survival and longevity of structures. Neglecting vibration management can have severe consequences. Failure to properly manage vibration has led to numerous failures across many different applications, from buildings to aerospace systems. Vibrations can lead to several different types of failures. For example, the structure can experience resonant vibrations when exposed to certain frequencies, or it can start self-oscillating due to interactions with its environment. These conditions can cause the structure's response to exceed its material limits, such as in the infamous Tacoma Narrows Bridge collapse, where wind-induced oscillation amplified until supporting cables failed, resulting in the bridge collapse.

Even if a structure doesn't fail right away, repetitive motion can lead to vibration fatigue, local contact welding, wear, or unexpected interactions. If the loading conditions can't be reduced or adjusted, the structure must be designed to survive by minimizing its vibration response.

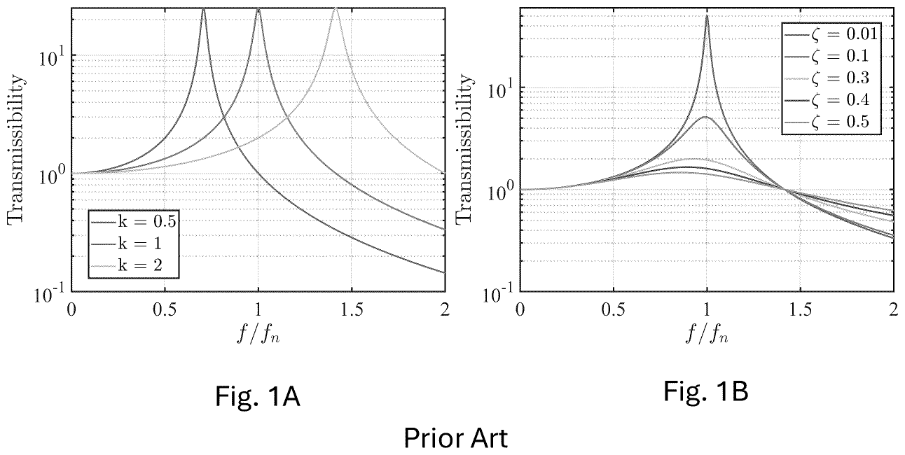

There are two primary approaches to designing structures to reduce vibration response. FIG. 1 illustrates the results of each approach using the transmissibility of a 1-Degrees of Freedom (DoF) mass-spring-damper (m, k, ζ) system.

The first approach, shown in FIG. 1A, involves modifying the structure's stiffness with the goal of moving the system response away from forcing. Vibration response reduction can be achieved by either stiffness reduction or stiffness increase. A common technique that employs the stiffness reduction technique is base isolation, where the system stiffness is intentionally reduced to shift the resonant frequency lower, resulting in attenuation at frequencies higher than the new resonant frequency. Alternatively, increasing stiffness reduces deformation under a given load, thereby increasing the resonant frequency. The vibration response tends towards no amplification for frequencies below the new resonant frequency. This can be achieved by utilizing more rigid materials or by changing the geometry to increase the second moment of area.

The second approach shown in FIG. 1B is through adding damping, where movement is allowed, and kinetic energy is converted into heat through dissipation mechanisms such as anelastic deformation, viscous dissipation, or friction. Removing energy from the system reduces the amplitude of the response. In general, this is achieved by incorporating damping devices or materials into the original structure to enhance survivability.

Vibration control is crucial for spacecraft. Currently, rockets are the only method for launching large payloads into space. As a result, all spacecraft must deal with the vibrational forces that come with rocket launches. These forces originate from various sources, each with different spectra and severity levels. These include the engine's unsteady combustion, turbulent interactions with the atmosphere along the rocket body or from exhaust gases, and shocks from explosive devices during stage separation.

Rockets not only cause these vibrations but also add further constraints to reducing vibration response. The finite dimensions of rocket fairings limit the size of the payload. Additionally, heavier payloads decrease launch capabilities and orbital range, leading to higher launch costs.

Due to these volume and mass constraints, there are strict limits on using the stiffness approach to mitigate spacecraft launch vibrations. The size of the structure, including any support elements, can only be increased up to the rocket fairing's volume limit. Adding dedicated supporting elements reduces the useful payload size and increases the proportion of the payload that becomes non-functional, or ‘dead mass’, in orbit.

While reducing stiffness through base isolation can be attempted, launch providers typically set lower limits for the first resonant frequency and generally require an additional frequency separation buffer to ensure a sufficient margin. This is done to prevent coupling between the payload and the rocket and to avoid interaction with Guidance, Navigation, and Control (GNC) systems.

Moreover, the actual usable space for a payload within a rocket fairing is further limited by the payload's dynamic envelope during vibration. This means that the payload's deflection due to vibrations must stay within this designated envelope throughout the launch. The increased compliance from base isolation could result in the payload impacting the rocket. For these reasons, base isolation does not scale well within the limited confines of a rocket fairing as the size and mass of the payload increase.

Switching to a stiffer, higher-modulus material is another option, but it typically results in a corresponding increase in the system's mass. Existing materials also impose a maximum limit on achievable stiffness.

Fundamentally, the main issue with relying solely on stiffness modification as a vibration reduction approach is that the shifted resonant frequency must be out of the excitation spectrum's band. If the excitation loading covers a wide range of frequencies, the resonant mode may still be excited, leading to amplification if there is insufficient damping. Therefore, damping is a necessary consideration in launch vibration mitigation, especially after pushing the stiffness design to its limits.

While various dampers are commonly used in vibration control, each has its own limitations. Many damping concepts add mass or increase compliance, reducing stiffness and necessitating a trade-off between stiffness and increased damping. These issues become more pronounced when considering scalability as the structure size or excitation levels increase.

The performance of many damping concepts is dependent on the excitation profile, such as frequency content, excitation amplitude, and loading rate. Some are only effective for specific frequencies or waveforms. This applies to Tuned Mass Dampers (TMD) and Tuned Liquid Dampers (TLD), as well as other damping devices that need tuning or have frequency-dependent responses, like the piezo damper.

Under non-harmonic excitation, such as random and shock, many of these concepts have limited effectiveness in reducing vibration response and may even amplify under certain conditions. This is common with concepts that use an inertial secondary mass due to the secondary mass's response lag and the inability to achieve resonance under non-harmonic or impulsive forcing.

Apart from the waveform spectra, the performance of certain dampers is influenced by factors such as excitation amplitude and loading rate. This sensitivity is commonly seen in viscous-type dampers, such as air or hydraulic shocks used in base isolation applications. For these damper types, low excitation amplitudes may result in inadequate stroke, which doesn't generate the necessary pressure in the working fluid for effective dissipation.

In addition, viscous dampers are rate-dependent, where the damping force is proportional to velocity. Under high frequencies or loading rates, the limiting behavior of these damping elements tends towards that of a rigid link, which transmits loads directly to the structure rather than attenuating them.

While there are evident challenges associated with the damping performance dependence on excitation profiles, profile independence may introduce its own set of difficulties. Certain damper types, like common implementations of coulomb-friction-based dampers, exhibit relatively low sensitivity to variations in loading rate or frequency content.

In addition to these issues, dampers designed for use in Earth's atmosphere face significant challenges when applied in the unique conditions of space, characterized by microgravity and vacuum. The conventional form of common damper types that are effective on Earth may exhibit reduced performance and reliability in the harsh conditions of outer space, necessitating careful evaluation and redesign.

Devices that rely on gravity may not operate or perform as expected in a zero-gravity environment. Furthermore, devices with fixed or preferred operational orientations face the challenge of constantly changing orientations relative to the gravity vector during launch.

Additionally, careful material selection is crucial to prevent contamination due to low pressure in a vacuum, which can lead to outgassing and boiling of liquids. Liquid-based dampers, therefore, need special pressurization or the use of more exotic working fluids.

Although many of these dampers can be generically implemented in a wide range of contexts and arbitrary structures, the concept of adding damping underscores that these types of dampers are not intrinsic to the original structure. Therefore, their addition increases the system's mass and complexity.

Particularly in structures for space applications, these added dampers generally result in an increased fraction of the launch mass that becomes ‘dead mass’, since they have no other function after reaching space where the vibration environment subsides.

These limitations and challenges highlight the need for a category of structures in which vibration mitigation is inherent to the structure itself. There is a need for a damping device configuration that not only leverages existing structural elements to establish a damping concept but also circumvents the constraints associated with other conventionally utilized damper types.

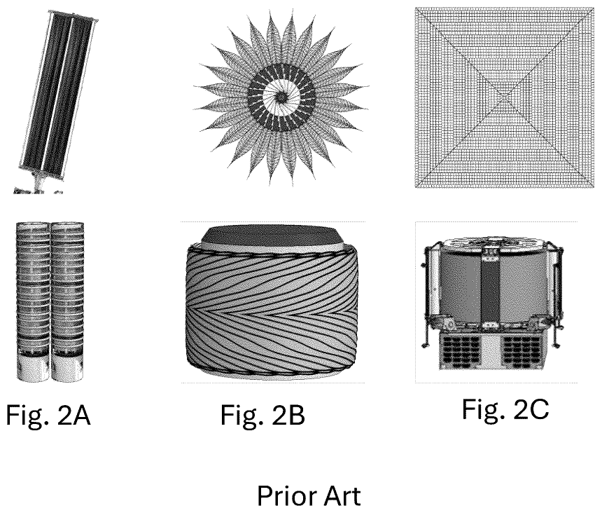

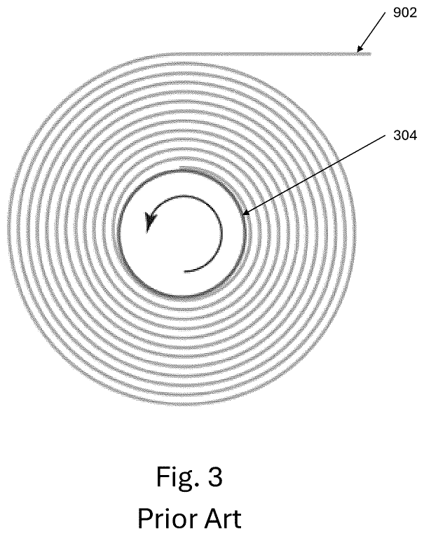

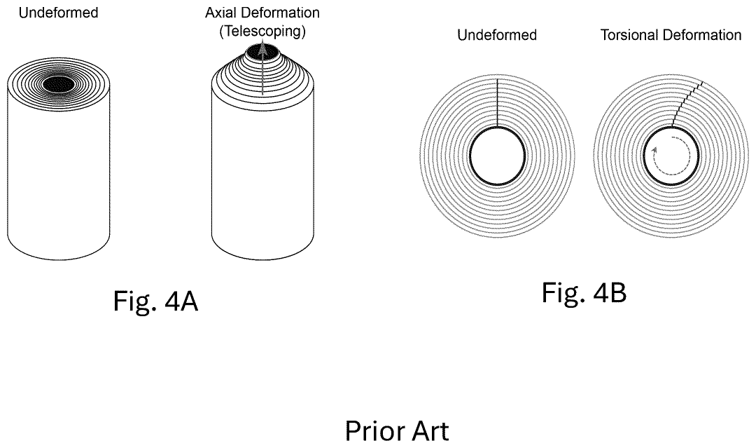

A coiled roll may be used as a passive, vibration damping device, which utilizes friction as the energy dissipation mechanism. As illustrated in FIG. 2A through FIG. 2C, space deployable structures such as the Redwire Roll-Out-Solar Array (FIG. 2A), JPL Starshade (FIG. 2C), and the Caltech Space Solar Power Project (FIG. 2C) notably use coiling as a packaging architecture. This allows these structures to be stowed compactly to fit within launch fairings. Generally, coils are tightly wound, as illustrated in FIG. 3, in which the deployable structured 302 is coiled around a mandrel, spindle fixture, or other structural component 304 to promote efficient packing and prevent coiling defects such as wrinkling, blossoming, and buckling. This winding tension also helps keep the layers of the wound roll restrained when subjected to loads. FIGS. 4A and 4B depict slipping deformation due to dynamic loading. FIG. 4A illustrates an axial slip, and FIG. 4B illustrates a torsional slip in wound rolls. Varying the winding tension affects the degree of interlayer slip observed in wound rolls subjected to dynamic loading. This happens because the winding tension controls the magnitude of friction forces between each layer.

Interlayer slip is typically seen as a defect, and materials are wound tightly during the coiling process to prevent it. However, friction, a non-conservative force, transforms mechanical energy into thermal energy and extracts mechanical energy from a system. This energy conversion mechanism of frictional interlayer slip has the potential to exploit a perceived drawback for practical purposes in reducing vibration response. When structures are in their coiled, stowed configuration for launch, the coil itself could provide an energy dissipation mechanism for damping, repurposing the existing mass to serve a dual function.

### EMBODIMENTS

This disclosure includes several embodiments directed to tensioned coil damping devices to be used as vibration damping devices and the methods of their manufacture and use. In accordance with numerous embodiments, these damping devices utilize friction and interlayer slip as an energy dissipation mechanism.

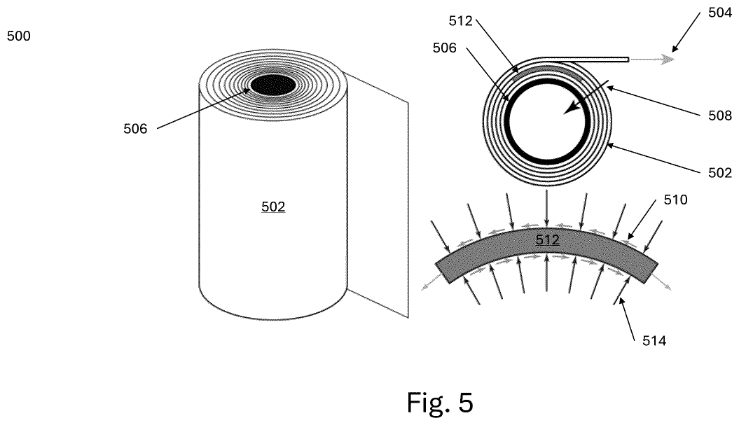

FIG. 5 illustrates a schematic of the wound roll damping device in accordance with some embodiments. Interlayer slip serves as an inherent method of providing vibration damping in a coiled structure 500. A wound roll 502 that's pretensioned 504 can generate friction damping. This roll 502 is wound around a mandrel or spool 506 with a specific tension 508 that permits a certain degree of interlayer slip during vibration. Coiling pretension 504 applies radial preload 508 to wound layers 512. Radial stresses 514 support interlayer friction forces that can be used to dissipate energy during vibration. The friction 510 created between the slipping layers 512 acts as an energy dissipation mechanism. This mechanism provides damping to the system as it vibrates, thereby reducing the overall level of excitation.

Many embodiments are robust, tunable, and scalable, exhibiting high performance, and are configured to increase the overall stiffness, as measured by the resonant frequency, while maintaining significant levels of damping. In accordance with numerous embodiments, if the excitation is large enough to cause an interlayer slip, friction dissipation will dampen the system regardless of the loading rate or waveform.

Various embodiments provide integral stiffness and damping. Many such embodiments provide tunable performance with winding tension. Numerous embodiments provide scalable damping through the propagation of slip to additional layers. Some such embodiments produce substantial damping without additional interfaces. In some embodiments, significant damping can be achieved with only one slipping interface.

Some embodiments are tunable by their points of contact. Some such embodiments are configured with nonuniform thickness, resulting in intermittent contact. Additional embodiments are configured with intentionally reduced contact areas to provide tunable performance. Other embodiments are configured with interfaces that are not continuous and are configured with cutouts and compositional discontinuities to tune the damping and stiffness capabilities. In many embodiments, at a selected level of excitation, only a partial region of the interface is engaged in slipping. Some such embodiments are tunable by configuring the material where the slip occurs. Yet other embodiments vary damping with factors such as structure stiffness, size, and coefficient of friction.

Various embodiments are tailored to different structural parameters, such as aspect ratios, sizes, and mechanical properties. Many embodiments offer substantial damping levels. Many such embodiments provide a significant decrease in vibration response at resonance, and some even approach virtually no amplification across some frequency ranges. Some embodiments produce a damping level of around 1%, while others are configured for orders of magnitude more damping.

In another embodiment, the coiling form factor allows for integral adjustability of the apparent stiffness in the coiled structure, offering advantages in structural design. In many such embodiments, the adjustability is configured by shifts to higher resonant frequencies with preload. In some embodiments, a sacrificial interface on or between the layers or structure can be employed. Some such embodiments are configured with sacrificial material when all layers within the coiled structure are fully constrained.

### Exemplary Embodiments

Experiments and modeling were conducted to predict and demonstrate the capabilities of wound roll damping devices and interlayer slip as a method of providing vibration damping in a coiled structure. These results and discussion are not meant to be limiting but merely to provide examples of operative devices and their features.

### Predicting Slip for Vibrations of a Coiled Structure

Stress on a wound roll due to vibration can be estimated using analysis and simulation. Structural analysis can provide estimates of high-stress locations, which are likely to initiate slip. These estimates are compared with simulation studies. The simulations start with the assumption that the coil has been pre-tensioned enough to prevent slip, making it behave like a solid object. This allows for finite-element analyses (FEA) to be performed using a simplified solid representation of the coil, instead of modeling each layer, which would be computationally expensive. This method has proven effective in simulating slip in dynamic roll hardness impact tests and is now being applied to vibration loading.

When considering the coil as a stiff solid, we need to understand the effective material properties of such a homogenized solid coil. Coiling creates an object with orthotropic properties. In cylindrical coordinates, the axial and circumferential stiffnesses, as well as the axial-circumferential shear stiffness, are related to the in-plane properties of the material being coiled. The other two components of shear stiffness and the radial stack modulus are affected by the coiling tension.

Experiments and roll quality measurements show that the shear stiffness of the coil varies with location in the roll and with winding tension. While it's difficult to find an exact relation between winding tension and the overall effective shear stiffness of the final wound roll, one approach involves simulating a range of shear stiffnesses.

As the effective shear stiffness of the roll is expected to vary with winding tension, even without slip, we can expect different vibration responses between a loosely wound roll and a tightly wound roll. Comparing the simulation results between shear stiffness configurations can illustrate how the vibration response is influenced by winding tension variations.

The proposed slip prediction approach is demonstrated using the geometry and properties of a hypothetical exemplary structure. First, the state of stress is calculated for a constant tension winding process, and the friction capacity is estimated. Then, a simulation is performed where a simplified solid, representing the coil, is attached to an elastic mandrel subjected to sinusoidal base excitation. The output of this model includes the stresses in the coil solid, with a focus on the shear stresses that can induce interlayer slip. If, at any point in the coil, the resultant of the shear stresses is below the frictional shear capacity, then no slip can occur, and the simplified solid model may be considered accurate. Conversely, this can also be used to determine at what locations a coil slips when the applied load exceeds the frictional capacity, and the solid assumption no longer applies.

### Interlayer Stresses in Wound Rolls

To determine the interlayer stresses in a wound roll, a nonlinear stress-field model that accounts for the anisotropy of the coiling process, where the effective radial modulus of a layered solid varies with stack compression, is used.

In this model, the wound roll, which in reality is geometrically a spiral, is approximated as a series of concentric cylinders that represent different coiled layers in order to study the winding process using an axisymmetric approach. Assuming that stresses within the wound roll are solely dependent on radial position and remain invariant with respect to axial or circumferential position, the problem is further simplified by adopting the assumption of plane stress. This allows modeling the coiling process as adding a series of tensioned rings in 2D.

Examining a segment of a coil wrap allows for the consideration of a free body diagram in order to illustrate the forces acting on a segment.

Equilibrium of this segment requires that the net forces in the radial and circumferential directions are balanced. Because of circular symmetry, circumferential equilibrium is automatically satisfied, and only the radial direction needs to be considered.

The radial equilibrium of the segment couples the radial and circumferential stresses and is given by:

$$r \frac{d {σ}_{r}}{dr} + {σ}_{r} - {σ}_{θ} = 0$$

Similarly, strain compatibility in cylindrical coordinates to ensure no gaps or overlaps is given by:

$$r \frac{d {ϵ}_{θ}}{dr} + {ϵ}_{θ} - {ϵ}_{r} = 0$$

The stress-strain constitutive relations for linear orthotropic materials are equations relating the strain, ϵ, stress, σ, moduli, E, and Poisson's ratio, ν, in the radial and circumferential directions and are given by:

$$Radial Direction : {ϵ}_{r} = \frac{{σ}_{r}}{{E}_{r}} - {ν}_{θ} \frac{{σ}_{θ}}{{E}_{θ}}$$

$$Circumferential direction : {ϵ}_{θ} = \frac{{σ}_{θ}}{{E}_{θ}} - {ν}_{r} \frac{{σ}_{r}}{{E}_{r}}$$

Combining the relations results in the winding equation:

$${r}^{2} = \frac{{d}^{2} {σ}_{r}}{{dr}^{2}} + 3 r \frac{d {σ}_{r}}{dr} + ( 1 - \frac{{E}_{θ}}{{E}_{r}} ) {σ}_{r} = 0$$

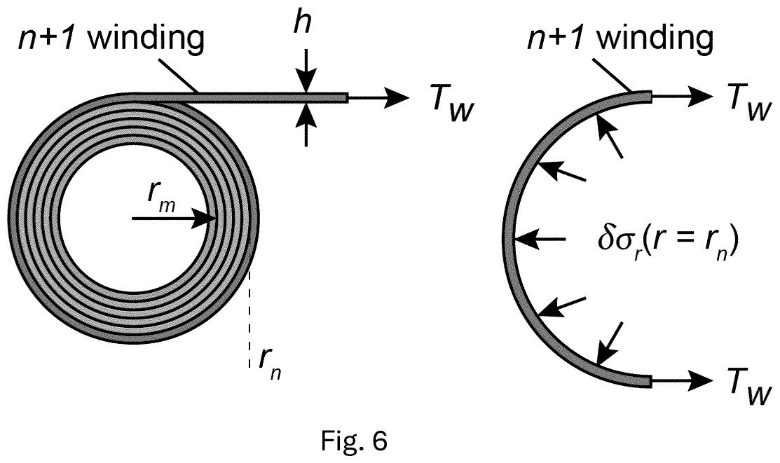

FIG. 6 shows the geometry for the model of the winding problem under consideration. The state of stress of the coil during the winding process changes with each additional winding. As such, if δσr (r) is the increment in interlayer pressure inside a roll, which currently has n layers and outer radius, r=rn, due to an additional n+1 winding, the equation can be rewritten as:

$${r}^{2} = \frac{{d}^{2} {δσ}_{r}}{{dr}^{2}} + 3 r \frac{d δ {σ}_{r}}{dr} + ( 1 - \frac{{E}_{θ}}{{E}_{r}} ) {δσ}_{r} = 0$$

The equation is a second-order boundary value problem subject to two boundary conditions. The first boundary condition states that the radial stress at the current roll outer radius, r=rn, due to an additional wrapping, is determined by the winding tension through the hoop stress relation. For a continuous sheet of constant thickness, h, and negligible bending stiffness, wound with tension that generates an in-line winding stress, Tw, the incremental interlayer stress, δσr, of an additional winding is given by:

$${δσ}_{r} = [ \frac{{T}_{w}}{r} ] h at r = {r}_{n} ( current outer radius of roll )$$

In principle, this model is general enough to take any arbitrary winding stress profile, Tw=Tw (r), but a constant tension stress profile is assumed here for simplicity. The second boundary condition is an additional statement of strain continuity be-tween the radial deflections of both the mandrel and the roll at the interface of the first winding:

$${r}_{m} \frac{d δσ \text{?}}{dr} = ( \frac{{E}_{r}}{{K}_{m}} - 1 + v \text{?} ) δσ \text{?} \qquad atr = r \text{?}$$

$$( outer radius of the mandrel )$$

$$\text{?} \text{indicates text missing or illegible when filed}$$

Here, Km is the mandrel stiffness, which relates the applied radial stresses to the corresponding radial deflection and is a function of the mandrel material and geometry. For an isotropic mandrel with material modulus, Em, Poisson ratio, νm, outer radius, rm, and inner radius, ri, the mandrel stiffness is given by:

$${K}_{m} = \frac{{E}_{m}}{\frac{{( {r}_{m} / {r}_{i} )}^{2} + 1}{{( {r}_{m} / {r}_{i} )}^{2} + 1} - {v}_{m}}$$

In this analytical model for winding stress, the majority of the material properties are assumed to remain constant during the winding process. However, the radial modulus of the coiled material, Er, is typically assumed to vary with the interlayer pressure. In experimental settings, the stack modulus of a layered solid is observed to depend on the number of layers and applied preload, exhibiting distinctive behaviors compared to an equivalently sized continuous solid or even a standalone layer.

The stress-strain curves of layered solids exhibit nonlinearity, possibly due to variations in layer-to-layer contact induced by factors such as asperities, air entrapment, thickness fluctuations, and the bending stiffness of the material. A typical expression for the radial modulus as a function of the interlayer stresses is derived from taking the derivative of experimentally measured stress-strain curves and is given by:

$${E}_{r} ( r ) = {K}_{1} {K}_{2} + {K}_{2} {σ}_{r} ( r )$$

The constants K1 and K2 can be determined through experimental measurements or obtained from materials that have already been characterized.

Because the boundary value problem depends on terms that are functions of radial position, r, this problem must be solved numerically. Here, the finite difference approach described is used, where a center difference approximation of the derivatives in the equation is used to generate the incremental winding equation for the nth winding:

$$\begin{matrix}{δσ}_{r , n + 1} [ {A}_{n} ] + {δσ}_{r , n} [ {B}_{n} ] + {δσ}_{r , n - 1} [ {C}_{n} ] = 0 \\ \\ A \text{?} ≡ 1 + ( 3 h / 2 {r}_{n} ) \\ {B}_{n} ≡ ( {h}^{2} / {r}_{n}^{2} ) ( 1 - {E}_{θ} / {E}_{r} ) - 2 \\ {C}_{n} ≡ 1 - ( 3 h / 2 {r}_{n} )\end{matrix}$$

$$\text{?} \text{indicates text missing or illegible when filed}$$

For a coil consisting of N windings, the equation can be expressed iteratively to obtain a system of N−1 equations with N+1 unknown interlayer stresses, δσr,1, δσr,2, . . . δσr,N, δαr,N+1:

$$\begin{matrix}{δσ}_{r , N + 1} [ {A}_{N} ] + {δσ}_{r , N} [ {B}_{N} ] + {δσ}_{r , N - 1} [ {C}_{N} ] = 0 \\ {δσ}_{r , N} [ {A}_{N - 1} ] + {δσ}_{r , N - 1} [ {B}_{N - 1} ] + {δσ}_{r , N - 2} [ {C}_{N - 1} ] = 0 \\ ⋮ \\ {δσ}_{r , 3} [ {A}_{2} ] + {δσ}_{r , 2} [ {B}_{2} ] + {δσ}_{r , 1} [ {C}_{2} ] = 0\end{matrix}$$

Here, δσr,N is the incremental radial pressure on the outside of layer N−1. The boundary conditions in the equations provide the necessary additional relations to solve this system of equations but must be expressed in discrete form. The equation can be rewritten directly as:

$${δσ}_{r , N + 1} = \frac{{T}_{w , N + 1}}{{r}_{N + 1}} h$$

Since there is no layer beneath the mandrel, the equation uses a forward difference approximation for the derivative instead of a center difference scheme:

$${r}_{m} \frac{{δσ}_{r , 2} - {δσ}_{r , 1}}{h} = ( \frac{{E}_{θ}}{{K}_{m}} - 1 + {v}_{θ} ) {δσ}_{r , 1}$$

The equations, in conjunction with the N−1 equations, form a linear system of N+1 equations with N+1 unknowns that can be represented as a matrix:

Ax=B

Where A is a tri-diagonal matrix containing the coefficients of the center difference approximation of the winding equation derivatives, x is a column matrix of the unknown interlayer stresses δσr,1, . . . δσr,N+1 to be solved for, and B is a sparse column matrix containing the boundary conditions. The equation can simply be inverted to find the interlayer stresses that arise due to the additional layer.

For a known number of layers and a given winding setup, this stress field model can be recursively applied, starting from the first layer until the last, to get the incremental radial stresses at each winding step. If the discrete stresses, found by solving the system for the nth winding, xn=[δσr,1, δσr,2, . . . , δσr,n, δσr,n+1], can be interpolated and represented as a continuous function of r as [δσr (r)]n, the summation of the contributions of incremental radial stress for each layer gives the total stress distribution:

$${σ}_{r} ( r ) = {\sum }_{n = 1}^{N} {[ δ {σ}_{r} ( r ) ]}_{n}$$

This provides the methodology necessary to determine the interlayer stresses at any location within a wound roll that results from the winding process.

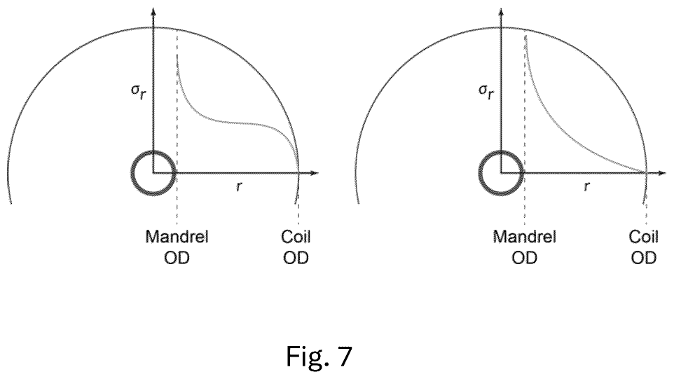

The shape of the stress field distribution through the coil is sensitive to the moduli of the material being coiled. FIG. 7 shows a notional comparison between a ‘soft’ roll (Eθ>>Er), where the material is much stiffer in tension than in radial, through thickness compression, vs. a hard roll (Eθ≈Er), where the radial and tangential properties are comparable. Regardless, since the additional winding compresses the other layers beneath it, the radial stress field, in general, will be maximum at the mandrel interface and tapers outwards for subsequent layers.

### Interlayer Friction Capacity of Wound Rolls

The previous section enables the estimation of the state of stress in a wound roll that arises due to a tension winding process. The compressive interlayer stresses, or, provide the normal reactions which are necessary for two surfaces to support friction forces. The next required component is a model to describe how these interlayer normal stresses relate to the friction forces that resist interlayer slip.

Friction is a complex phenomenon that can demonstrate nonlinear behaviors contingent on various factors such as velocity, preload magnitude, time, and temperature. However, this work utilizes the Coulomb friction model, which is widely used because it provides a simple way to describe the frictional forces between two surfaces in relative motion and has demonstrated good predictive capability in experiments.

For two solid surfaces in contact, the friction force between the surfaces that resists relative motion, Ff, is proportional to the normal preload, Fn:

Ff≤μFn

The constant of proportionality here is the coefficient of friction, μ, which is typically obtained through empirical measurements. This relation can be extended to the cylindrical contact surfaces in wound rolls, using stresses rather than forces. The frictional shear capacity, σc, is defined as the maximum stress a layer can support without slip. Under the Coulomb model, the shear capacity is proportional to the interlayer stress through the coefficient of friction, μ:

σc=μσr

Because this model simply linearly scales the stress field model calculated previously, the variation of the friction capacity through layers follows the same shape as the stress-field seen in FIG. 7. Therefore, the shear capacity is maximum at the mandrel interface and tapers outwards for subsequent layers.

### Shear Resultant Metric

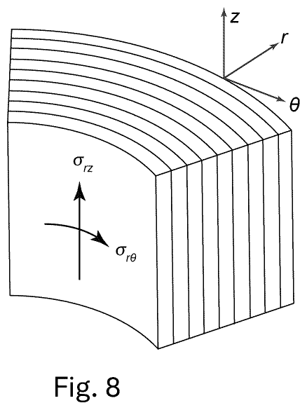

The friction capacity provides the stress threshold that delineates between no slip and slip conditions. In order to assess against the threshold, the stress directions that can induce slip and determine the loading magnitude are needed. The deformation directions for a wound roll that result in interlayer slip correspond to the out-of-plane axial and in-plane shear directions shown in FIG. 8. The expected interlayer slip mode for axial shear, σrz, is telescoping (FIG. 4A), while in-plane shear, σrθ, can result in torsion (FIG. 4B).

In the analytical stress models, it was assumed that there is no circumferential or axial variation of stresses, and hence there is likewise no directional variation in shear capacity at a radial interface. The primary focus here is to determine the occurrence and location of slip, rather than the specific direction of slip. Therefore, it suffices to solely assess the magnitude of the resultant stresses at a given point. As a result, σs, the resultant of the out-of-plane and in-plane shear stresses at a point can be calculated from:

$$σ s = \sqrt{σ rz 2} + σ r θ2$$

The shear resultant at any point in the coil can then be compared against the estimated shear capacity at that layer to determine the state of slip:

$$Slip State = \{ \begin{matrix}no - slip & if {σ}_{c} \geq σ \text{?} \\ slip & if {σ}_{c} < σ \text{?}\end{matrix}$$

$$\text{?} \text{indicates text missing or illegible when filed}$$

This criterion can now be used in conjunction with analytical models or FEA to determine where a coiled structure will slip under vibration loading.

### Determining Approximate Locations of Slip Via Analytical Stress Estimates

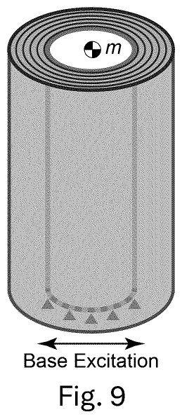

In order to determine whether slip occurs, the distribution of stresses inside the coil that result from vibration are required. The mounting configuration considered is one where the supporting mandrel is mounted in a cantilevered configuration. Here, the mandrel is base fixed, but the coil is not and is attached only to the mandrel, as illustrated in FIG. 9.

With the additional constraint that the ends of the mandrel are held to remain circular, and the likelihood that there is some tip mass bias, the vibration mode of wound rolls is expected to be a bending mode for a wide range of configurations. As such, this entire body of work assumes that the primary mode shape of a cantilevered wound roll under vibration is a bending mode. With the loading state of interest defined, simple analytical models can be used to predict locations of high stresses.

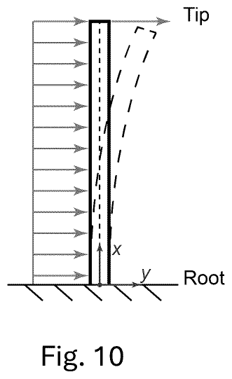

Assuming a bending vibration mode, the loading of the wound roll assembly due to base excitation can be approximated as a cantilever beam with under a uniformly distributed load and a tip load as shown in FIG. 10. Here the beam considered only accounts for the mandrel, where the stiffness and dimensions of the wound roll are not considered in the beam properties. Only the inertia of the roll is accounted for in the magnitude of the uniform loading.

Using this approximation, there is no direct information given for the stresses inside the wound roll. However, there are closed form analytical expressions for the stress distributions expected inside the base-fixed mandrel. These distributions can be used to estimate the traction that the mandrel would apply on the wound roll during vibration. Since the wound roll boundary conditions are otherwise free, except at the mandrel interface where the roll is attached, the highest stresses are expected to occur at that interface and decay outwards.

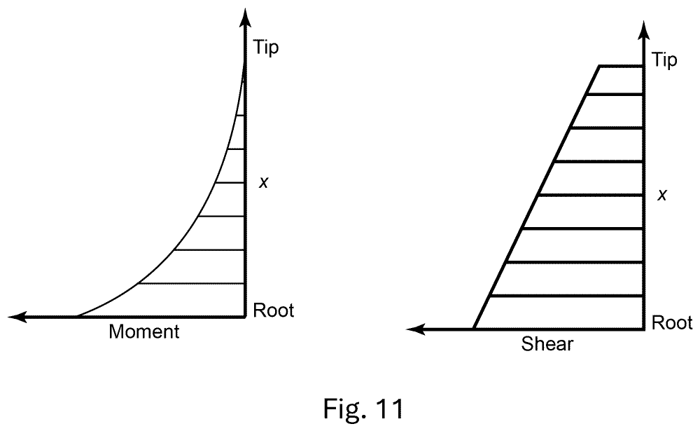

This combination of loading for a cantilever beam does not result in pure bending, so shear forces exist. This can be notionally demonstrated in the shear and moment diagram for this loading in shown in FIG. 11.

When considering the failure loads of cantilever beams, two metrics to consider are the bending and shear stresses. The relations for the bending and shear stresses as a function of the axial position, x, and the distance from the neutral axis, y, is determined by the distribution of shear forces, V, the moment, M, and the second moment of area, I. The stresses are given by the expressions in the equations:

$$\begin{matrix}σ ( x , y ) = \frac{M ( x ) y}{I} \\ τ ( x , y ) = \frac{V ( x )}{It} \begin{matrix}J \\ \end{matrix} ydA\end{matrix}$$

In FIG. 11, the largest shear and moments are located near the root for x=0. This identifies the root cross-section as a location of interest for high stresses. The next step is to determine where, within the root cross-section, are the stresses highest.

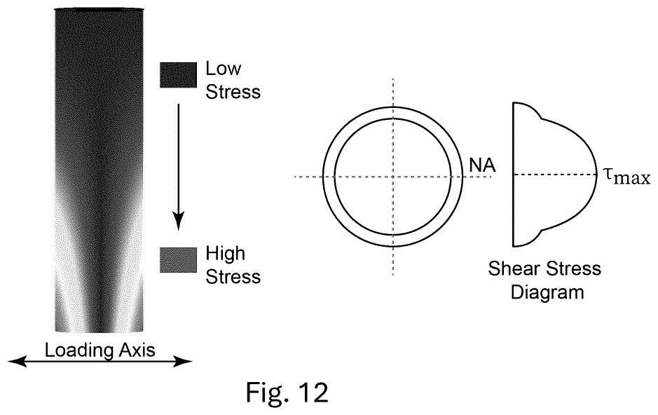

From the bending stress relation in the equation, the stress is linearly proportional to the distance away from the neutral axis through y. Thus, the highest bending stresses are expected at the outer surfaces of the mandrel aligned with the loading axis as illustrated in FIG. 12. This implies that the interface at the root, between the mandrel and coil, on the surfaces aligned with the vibration axis is likely to be significant for interlayer slip.

From the transverse shear stress relation in the equation, the term in the integral is the first moment of area between the location where the shear stress is being calculated and the neutral axis where the shear stress is zero. In the case of a cylinder, this result indicates the maximum transverse shear stress occurs at the neutral axis as illustrated in FIG. 12.

These simple analytical expressions provide an approximate indication of the locations where slip initiation can be anticipated. More detailed predictions of slip can be obtained from FEA where the vibration of a wound roll can be simulated and used to directly compute the stress resultants at every point inside the coil.

### FEA Approach to Predict Interlayer Slip

This section demonstrates the slip prediction approach using FEA by studying the vibration of a notional structure. The material properties are derived from a coilable structure currently under development at Caltech, and the geometry is informed by scaling a portion of the structure to a larger size. First, the friction capacity of the coiled structure is estimated for assumed winding parameters. Then, the capacity is compared to the shear stress resultants obtained from a FEA simulation of the wound roll under vibration loading.

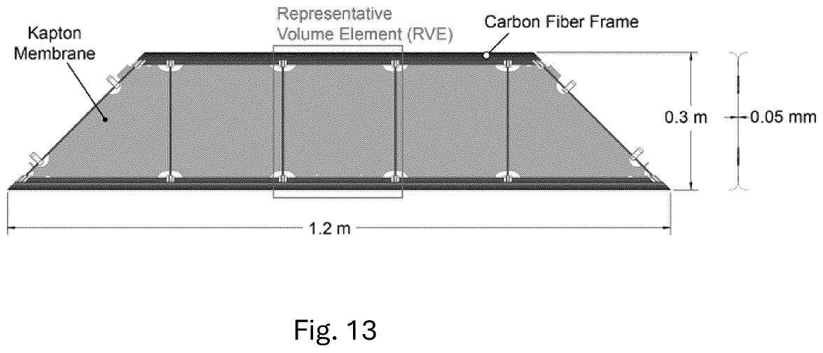

The structure of interest is a segment of the Caltech Space Solar Power Project (SSPP) structure called a ‘strip’, which consists of an ultra-thin, sparse carbon fiber structure, with large cutouts, supporting a Kapton membrane as show in FIG. 13.

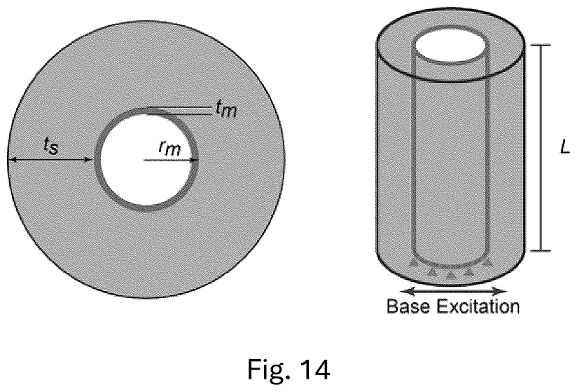

This study assumes that there is a strip that is long enough to form 300 coiled layers around a 300 mm tall, aluminum mandrel with a 2 cm outer diameter and 1 mm wall thickness. The outer diameter of the final packaged coil is expected to be approximately 5 cm as illustrated in FIG. 14. The dimensions of the mandrel-coil system are shown in the table below:

| rₘ (mm) | tₘ (mm) | L (mm) | tₛ (mm) |
|---|---|---|---|
| 10 | 1 | 300 | 15 |

### Expected Shear Capacity Due to Winding

To determine the shear capacity of the coil using the winding model of interlayer stress, the structure is homogenized during the winding process as a sheet which has a uniform thickness, h, that is coiled with a constant winding stress equal to approximately half the tensile yield stress of Kapton. Additionally, the coefficient of friction between layers corresponds to the reported values of Kapton-Kapton coefficient of friction.

The chosen winding parameters and the assumed coiled structure material parameters are shown in are shown in the tables below. Note that the coefficients, K1 and K2 for the nonlinear stack modulus are obtained from, assuming Kapton has similar compression behavior as polyester.

With these values, and the geometry in table above, the interlayer stresses as a function of radial position in the coil are calculated according to the process laid above and the capacity is then found by scaling the result by the coefficient of friction as denoted.

### Winding Parameters

| Property | Value | |
|---|---|---|
| Winding stress, T_{w} ≈ 0.5_{σY, Kapton} | 40 | MPa |
| Structure thickness, h | 0.05 | mm |

| | |
|---|---|
| Number of layers, n = tₛ/h | 300 |
| Coeff. friction, μ | 0.48 |

### Coiled Structure Material Parameters

| E_{θ} | Eₘ | K₁ | K₂ |
|---|---|---|---|
| 10 GPa | 70 GPa | 1 kPa | 40 GPa |

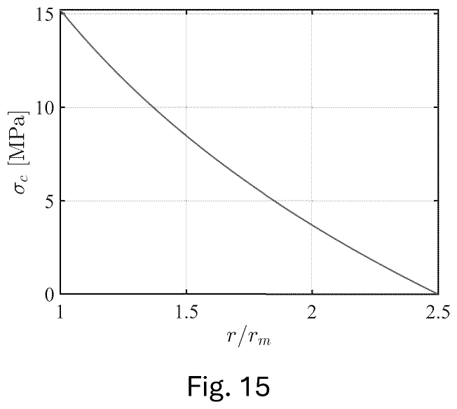

The shear capacity as a function of the radial position is shown in FIG. 15. Here, the horizontal axis is normalized by the mandrel radius, rm. FIG. 15 indicates as expected, the innermost layers are expected to have the largest shear capacity, and hence resistance to slip is largest at the mandrel-coil interface and reduces radially outward. The shear capacity must now be evaluated against the vibration induced shear stresses from FEA to determine where slip occurs in the coil.

### Homogenized Solid Approximation of Coils for FEA

Rather than modeling discrete windings of the wound structure, which is computationally expensive, this effort begins with the coiled-stiff assumption where the coil is assumed to be tensioned sufficiently that no interlayer slip occurs and it behaves mechanically as a continuous solid. Thus, the model consists of a homogenized solid, with material properties calculated from a representative volume element (RVE) of the structure of interest (FIG. 13). The unit cell of the structure consists of carbon fiber framing supporting a Kapton membrane. Where relevant, the material properties are calculated according to the weighted mean of all constituent materials, for example in the case of certain moduli, or determined from the properties of the membrane when its properties are the limiting factor.

The material properties of this homogenized solid are transversely isotropic to emulate the orthotropy of a wound roll. Using cylindrical coordinates: Eθ, Ez, and Gzθ are defined by the in-plane properties of the structure of interest. The moduli that are directly affected by the coiling process are the radial modulus, Er, and the shear moduli, Grz and Grθ. As discussed above, Er is dependent on the number of layers in the stack and increases the more tightly the coil is wound. The value of Er must be found experimentally through compression testing; however, here, Er=1% Eθ is assumed, which is a typical order of magnitude result from stack compression experiments on wound roll materials.

The remaining unknown moduli that are impacted by the coiling tension are the shear moduli Grz, and Grθ. As the coiling tension increases, the interlayer frictional shear capacity also increases, and this should result in a measurable increase in the shear stiffness of the wound roll. Variation in the effective stiffness of an object can generally be measured indirectly via vibration testing, as the resonant frequency correlates with moduli. Thus, in this work, rather than directly measuring the effective shear stiffness variation with winding tension, changes are assessed indirectly using the resonant frequency of vibration.

For this study, Grz and Grθ are assumed to be identical, which is consistent with the assumptions that there is no axial or circumferential variation in shear capacity. Under this assumption, a range of values are studied to determine the vibration response sensitivity to shear stiffness for the first study. Next, to determine the loading stress distribution from vibration for the second study, only one value of shear stiffness is needed. Here, the maximum shear stiffness from the range considered in the first study is selected, which corresponds to the scenario where the contributions of shear stiffness in this homogenized RVE come from an isotropic material: Gzθ=Grθ=Grz. This condition is considered the maximum theoretical limit of effective shear stiffness, where regardless of winding tension, the stiffness of a wound roll is not expected to exceed that of a continuous solid.

The material properties used in this simulation are found in the table below. While modeling a wound roll as a homogenized solid does not provide information about damping, these simulations indicate the sensitivity of the vibration response of this configuration to winding tension in the no-slip regime.

### Homogenized Structure RVE Material Parameters

| E_{θ} | E_{z} | Eᵣ | | G_{zθ} | G_{rθ}, G_{rz} | ρₛ |
|---|---|---|---|---|---|---|
| (GPa) | (GPa) | (GPa) | νᵢⱼ | (GPa) | (GPa) | (kg/m³) |
| 10.0 | 5.0 | 0.1 | 0.3 | 1.0 | 0.1-1.0 | 1600 |

### FEA Model Setup and Simulation Procedure

The FEA model studies the configuration where the homogenized coiled structure is supported by an isotropic, aluminum mandrel, fixed in a cantilevered configuration. The mandrel is defined by the wall thickness tm, length L, and outer radius rm and is modeled using S4R shell elements. The coiled structure is defined by its thickness

ts and length L and is modeled using C3D20R solid elements. The structure is assumed to be perfectly bonded to the mandrel's outer diameter, but not to the mandrel's base (FIG. 15).

The finite element software ABAQUS was used to perform two studies. The first study investigates how the 1st bending mode resonant frequency varies with the shear stiffness of the coiled-solid. The resonant frequency here is used as an indirect gauge of the apparent stiffness of the modeled assembly. Loosely wound rolls are anticipated to demonstrate lower apparent stiffness, which should correlate to lower resonant frequencies compared to tightly wound rolls.

The second study sets Gzθ=Grθ=Grz to estimate the loads where slip is expected to occur in a coil under transverse vibration loading. First, a linear frequency analysis is performed on the assembly, extracting the first 10 modes. This model is then used in a modal dynamics step, where the transient response is determined using the extracted modes of the system as a basis. In the dynamics step, the structure is subjected to sinusoidal base excitation at the first natural frequency of the system in order to subject the assembly to the highest loads, using a span of acceleration levels from 1-15g.

In this model, interlayer slip is not accounted for, so there is no damping in this model up to this point. However, some level of damping must be included to have finite acceleration. Here, a modest 2% damping is assumed across all modes. The model is run for a duration sufficiently long for the maximum displacement of the structure to reach a steady state. The observed peak shear stress resultant and corresponding location in the roll during the steady state response is recorded for each acceleration level and is compared against the shear capacity to determine the regions where slip would be expected.

Vibration Response Variation with Shear Stiffness

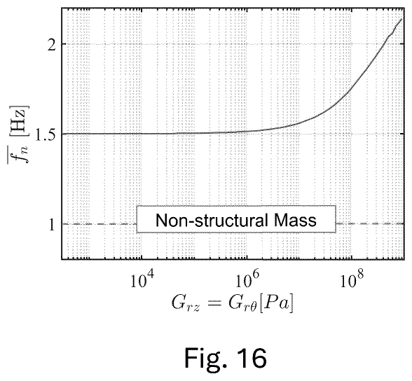

First, the variation in wound roll vibration response with shear stiffnesses is examined. FIG. 16 shows how the 1st bending mode resonant frequency of the wound roll assembly changes with shear stiffness. Note that for low values of shear stiffness, the bending mode is not the fundamental, i.e., the lowest resonant frequency, mode. Usually, the lowest mode for low shear stiffness corresponds to either axial or torsional shear. However, the mass participation factors of these modes is much lower than the bending mode, so they are discarded.

The red line in this plot corresponds to the case where the coiled solid is removed from the model, and instead, its inertia is uniformly distributed along the mandrel as a non-structural mass. This represents the case where the coil is not providing stiffness to the assembly and behaves only as an added mass. The y axis for this plot is normalized by the resonant frequency of the non-structural mass case.

This plot demonstrates that there is a geometric benefit to coiling. For all shear stiffnesses considered, the resonant frequency of the wound roll assembly is higher than that of the non-structural mass case. This result is significant as it indicates the advantage of using the wound roll as a structural element. Taking into account the coil geometry leads to improvements in properties, such as increased cross-sectional area and second moment of area, thereby contributing to enhanced stiffness.

Furthermore, there is a range of low shear stiffnesses, where the variation in response is minimal, as evidenced by a relatively flat curve. Beyond this range, there is a critical threshold of shear stiffness where the assembly response becomes notably more sensitive to increasing shear stiffness. Because shear stiffness is positively correlated with winding tension, this suggests that vibration response of wound rolls can vary significantly with winding tension. This property is exploited in a later section for experimental design. To proceed to the second FEA study, only one value of shear stiffness is needed. Here, the largest value of shear stiffness in the range considered is selected, which corresponds to the most tightly wound, slip resistant roll.

Locations of Slip within a Coiled Structure Under Vibration

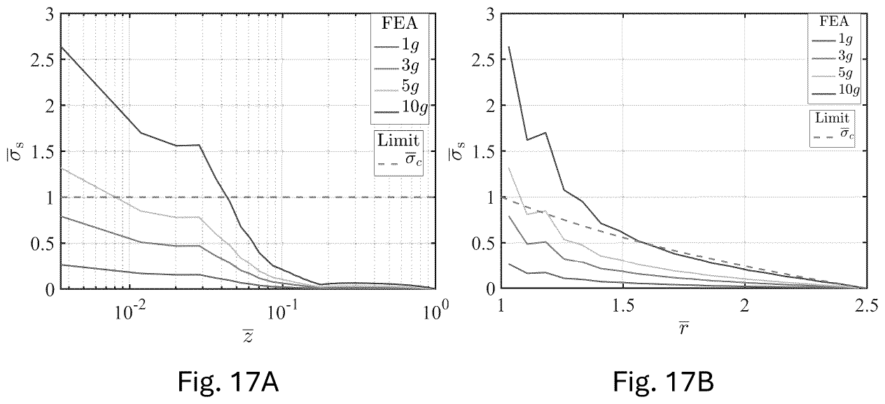

In the second study, the coiled stiff structure is subjected to base vibration with a range of excitation levels at the assembly's natural frequency, fn≈100 Hz, where resonance is expected to exhibit the highest loading. The stress components extracted from the vibration simulation are used to compute the stress resultant at every point in the roll. The stress resultants are then consolidated into a histogram and plotted against the axial and position in the coil, shown in FIGS. 17 A and B, to identify regions of high shear stresses. Superimposed on these plots is the maximum shear capacity at the corresponding radial or axial position estimated previously. Note that the shear capacity was assumed to vary only radially, and is invariant to axial position. Thus, in the axial direction, the maximum shear capacity curve is constant, as denoted by the red horizontal dotted line in FIG. 17A. The horizontal axis of the axial distribution plot in FIG. 17A is normalized by the length of the assembly, L=300 mm. The horizontal axis of the radial distribution plot in FIG. 17B is normalized by the radius of the mandrel, rm=10 mm. The vertical axis of both plots is normalized by the maximum shear capacity, max(σc).

In the axial direction, the maximum stresses are at the base of the structure (FIG. 17A). This is consistent with the initial analytical estimates, where the highest moments and shear stresses are at the base. In the radial direction, the maximum stresses are at the mandrel interface (FIG. 17B). These results confirm that the innermost layers, towards the root of the coil, are subject to the highest vibration induced shear stresses.

To identify the slip locations, the stress resultants' magnitudes can be assessed in comparison to the shear capacity. Whenever the stress curves exceed the red shear capacity limit lines in FIGS. 17 A & B, slip is expected to occur. For magnitudes of excitation less than approximately 5g, no slip is expected anywhere. This result indicates that there exist combinations of load, friction, and structural response configurations where modeling a coil as a homogenized solid may be considered a valid assumption. For a given loading, the extent of slip can be modulated by varying the coiling tension or the coefficient of friction between layers to raise or lower the shear capacity.

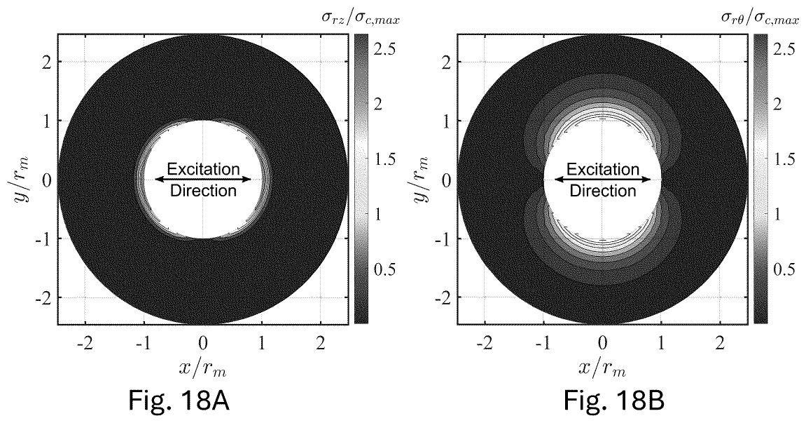

To more precisely pinpoint the slip locations, the stress components from the bottom most cross-section of the coil, which experiences the highest moments and shear, can be displayed. The contour plots in FIGS. 18 A and B depicts the magnitude of extracted stress components at the root of the coil due to 15g excitation, normalized by the maximum shear capacity.

Observe that the highest stresses for both components of shear are at the coil-mandrel interface and decay outwards. The maximum out-of-plane axial shear stress, σrz, shown in FIG. 18A is almost twice as large as the maximum in-plane shear stress, σrθ shown in FIG. 18B. This indicates that the bending mode of vibration is more significant for slip initiation than transverse shear. Despite this, the effect of transverse shear through σrθ extends for a larger radial distance in the coil, which indicates that a relatively larger number of layers are affected by in-plane shear due to vibration loading (FIG. 18B). These locations are consistent with the predictions from analytical estimates, which identified the surfaces aligned with the excitation direction as well as the neutral axis as locations of interest.

The FEA of the coiled-stiff model suggests that, despite exhibiting the highest interlayer stresses and consequently the highest expected slip resistance, the innermost layers near the root are prone to slipping first. This result highlights these areas as locations of particular interest when evaluating slip in wound rolls, whether for engineering these surfaces to enhance slip damping performance or to prevent interlayer slip.

### Experiment Design for Sensitivity to Coiling Tension

The findings of this section indicate two key results that are relevant for designing an experiment to study the vibration response of this damping concept. The first is that winding tension can have a significant effect on the vibration response of a wound roll, as measured with resonant frequency. The second is that the locations of slip are expected to initiate from a relatively small region. These results suggest that the behaviors of this damping concept can be studied on a wound roll that contains relatively few number of windings.

For a small scale experimental study, a mandrel-coil assembly that is highly sensitive to coiling tension variation is desired in order to provide the largest disparity in resonant frequency of vibration. This allows for clear differentiation between the responses of ‘loosely’ and ‘tightly’ coiled states. The previous FEA framework is reused to repeat the sensitivity analysis of the vibration response performed in Section 2.4 to design a test sample for experiments.

For simplicity, the coiled material for this experiment was chosen to be 25 layers of continuous Kapton membrane. The number of layers selected here was motivated by considerations for subsequent experiments, and involved a compromise between opting for the minimum number of layers for convenience, while ensuring an ad-equate number of layers to capture interesting behaviors. The material properties of Kapton employed in the simulation are detailed in the bale below. In this study, the Kapton is assumed to be isotropic (Eθ=Ez) and a range of in-plane moduli is considered to encompass the various reported values of Kapton properties. As before, the radial stack modulus, Er, was assumed to be 1% of the maximum in-plane moduli considered.

### Kapton Parameters

| E_{θ} (GPa) | E_{z} (GPa) | Eᵣ (GPa) | νᵢⱼ | ρₛ (kg/m³) | h (mm) |
|---|---|---|---|---|---|
| 2.5-4.0 | 2.5-4.0 | 0.04 | 0.35 | 1400 | 0.05 |

Since the shear moduli are not directly measured, a range of values is considered up to the isotropic limit:

$${G}_{r θ} = {G}_{rz} = \frac{E}{2 ( 1 + ν )} for {E}_{θ} = {E}_{z} = 4. GPa$$

The disparity in resonant frequency, Δf, is defined as the difference between the natural frequency corresponding to the minimum value of shear moduli required to have a fundamental bending mode, and the natural frequency obtained with shear moduli equal to the isotropic limit.

In order to design this experiment, only the modal frequency extraction step of the coiled-stiff FEA model was reused to help choose a mandrel that would be most sensitive to changes in the winding tension of the selected membrane and number of windings. A range of mandrel materials and geometries was considered, and the most sensitive configurations corresponded to mandrels with lower modulus and thinner wall thickness. Selecting a mandrel of lower stiffness, closer to the stiffness of the coiled material under test, and thinner wall thickness allows a limited number of windings to have a more pronounced effect.

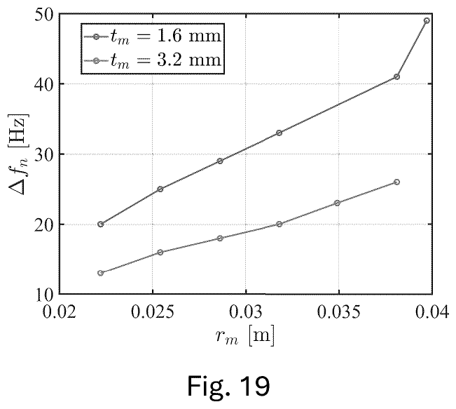

FIG. 19 shows how the disparity in resonant frequency varies with mandrel radius and mandrel wall thickness for polycarbonate mandrels. This material was selected for its modulus, which is the most similar to that of Kapton among the materials considered. FIG. 19 also demonstrates that the frequency disparity increases with mandrel diameter. The significance of this result is that if the wound layers actually behave as a solid, the added layers from coiling effectively augment the thickness of the mandrel, resulting in increased stiffness. This suggests that the stiffening effect associated with the coiling scales with the size and stiffness of the structure being coiled. The geometry and material property used in simulation to design the mandrel are presented in the table below. As a result of this design study, a polycarbonate mandrel was fabricated from stock material and sized to fit the physical extents and measurement bandwidth of the experimental test setup.

### Mandrel Simulation Design Geometry and Properties

| rₘ (mm) | tₘ (mm) | L (mm) | Eₘ (GPa) | ρₘ (kg/m³) |
|---|---|---|---|---|
| 40 | 1.6 | 300 | 2.7 | 1200 |

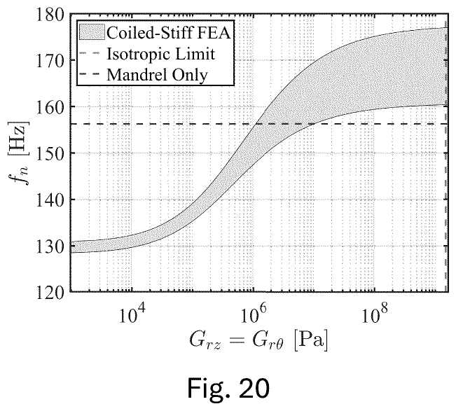

FIG. 20 shows the variation in resonant frequency with shear stiffness for the selected experimental configuration. Additionally, the resonant frequency of the mandrel by itself without the coil is plotted as well. Note that these results include a 0.05 kg tip mass that was added to the mandrel to bias the resonant frequency to a lower range.

The expected disparity between the loosest and tightest possible configurations is between 30-50 Hz, depending on the actual modulus of Kapton. For effective shear stiffnesses below approximately 1 MPa, the resonant frequency of the roll assembly is lower than that of the mandrel by itself. This indicates that the roll does not provide significant stiffness to the assembly in low winding tension regimes, and behaves more as an added mass.

However, for sufficiently large values of shear stiffness, i.e., coiling tension, the resonant frequency of the wound roll assembly can exceed that of the mandrel alone. If this increase in stiffness is observed experimentally, this would demonstrate an advantageous property of this concept, where the geometric benefits of coiling are leveraged to provide stiffness to the system in addition to damping. The potential advantage is particularly exemplified by the choice of wound material here. In this application, this data suggests that the coiling process imparts structural integrity to the Kapton membrane, which, when unsupported, lacks the ability to withstand compression. However, coiling combines the influence of numerous layers to provide out-of-plane support for each layer in the roll. Consequently, the geometry of coiling is capable of turning even films into structural elements that contribute stiffness to the system, instead of merely adding non-structural mass.

A method for estimating the slip resistance at any location in a tensioned, wound roll using shear capacity estimates derived from the interlayer stresses was determined. This methodology is demonstrated using an FEA model of a notional coiled structure supported by a cantilevered mandrel. The locations of maximum shear stresses from FEA are consistent with expectations of elementary structural analysis, and indicate the locations where slip is expected to initiate from during vibration loading. If the vibration mode of a cantilevered wound roll structure is a bending mode, slip is expected to occur at the root, near the interface between the first wound layer and the mandrel.

Analyzing stress variations across different excitation levels indicates that there are combinations of friction properties, preloads, structure characteristics, and excitations where vibration stresses are projected to remain below the shear capacity everywhere in the wound roll. Consequently, in these instances, no slip is anticipated within the coil. This outcome suggests regimes where modeling the coil as a homogenized solid could be deemed a valid assumption. For a given structure configuration, increased excitation levels can cause the response to transition from “no-slip” to “slip”. This suggests a discriminatory behavior of this concept: “activation” of this damping concept occurs selectively, responding only when necessary for sufficiently high loads.

Finally, the findings suggest that an observable distinction in vibration response is expected between “loosely” wound and “tightly” wound rolls, as assessed through resonant frequency measurements, which is used as an indirect measurement of the effective stiffness of the wound roll. This implies a potential advantage of the wound roll damping concept: harnessing the geometric benefits of coiling for integral stiffness adjustment, offering a more scalable approach to vibration response mitigation.

### Wound Roll Vibration Experiments

The slip prediction methodology discussed in the previous section provided an estimation of the slip locations inside a wound roll during vibration and the anticipated variation in vibration response with winding tension in the limit where no slip is expected. This was used to design a test sample that would, in theory, show high response sensitivity to winding tension for a limited number of wound layers. Using this test sample, two sets of experiments are performed to investigate the no-slip and slip regimes. The objective of these experiments is to understand the variation in vibration responses indicated by the initial findings of the previous section, as well as to determine the vibration reduction effectiveness of this damping concept.

### No-Slip Regime: Stiffness Variation

The simulation model used previously assumed that the notional structure in the coiled configuration behaved as a solid with an assumed value of shear moduli, Grz and Grθ, which are related to the tightness of the winding. The utility of the vibration simulation results that indicate regions and load levels where slip occurs is contingent upon the validity of the coiled-stiff model in two aspects. First, that a non-continuous, layered solid that does not undergo slip can dynamically demonstrate the same behavior as a continuous solid. Second, that the range of variation in effective shear stiffness considered is achievable with realistic coiling tensions and contact interactions.

To confirm these two aspects in experiments, the variation in effective shear stiffness of the wound roll assembly with winding tension is measured indirectly using the fundamental frequency of vibration. For these experiments, the structure is intentionally excited at low amplitudes to bias the response of the wound roll towards the no-slip regime for the test structure and range of winding tensions achievable. If the span of fundamental frequencies of the coil system across a range of winding tensions matches that of an equivalently sized solid, then the treatment of the roll as a continuous solid can be considered valid.

### Slip Regime: Damping Effectiveness

After studying the behavior of the wound roll damping concept in the no-slip regime, the response in slipping regimes can be studied to assess the damping efficacy. This is done by performing modal characterization of a wound roll assembly using a sine sweep test in order to determine how the frequency response of the test sample varies with winding tension. Damping is extracted from the experimental frequency response spectrum by using the half-power bandwidth method on the first peak acceleration response.

The performance of this damping concept is also characterized for additional types of loads, such as random vibration and impulsive shock loading. In many practical applications, loads experienced by materials or structures are not constant but vary randomly due to factors such as changing environmental conditions or operational variability. Thus, this set of experiments is performed to check how this damper operates in more realistic loading conditions, in order to assess excitation profile dependence.

Finally, to confirm that interlayer slip is the mechanism for energy dissipation, layer slip is measured experimentally. Comparing measured slip locations against simulated predictions is done to confirm understanding of how the vibration dynamics dictate the active regions within the coil for the wound roll damper concept. To measure slip, reference tracking targets are placed at several locations along the length of the mandrel. As a single, continuous membrane is wound around the structure, additional tracking targets are placed on alternating layers, concentric to the base reference targets. The wound roll is then excited using a sine dwell test at the natural frequency of the assembly, and a high speed camera captures the position of the tracking targets. Measurements are performed both axially and transverse to the axis of vibration. The high speed camera images are processed by identifying the centroids of the targets, where the difference between the layer target and the reference indicates slip relative to the base structure, and the difference between layer targets indicates interlayer slip.

### Wound Roll Test Sample Preparation

The vibration test sample consists of one continuous sheet of 2 mil thick Kapton®HN membrane, sufficiently long to wind 25 layers around the selected polycarbonate mandrel via a winding machine. The materials and geometry of this experiment were chosen so that a relatively small amount of layers would have a sizeable impact on the structural response of the system. Note that the stiffness and mass of the constituent materials of the mandrel and membrane are approximately equal.

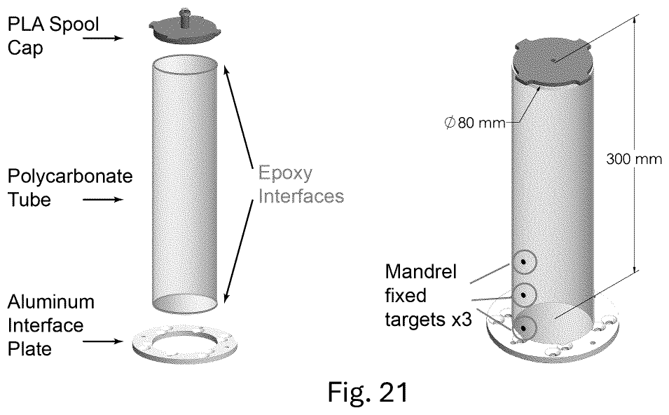

The mandrel consists of a polycarbonate tube, approximately 80 mm in diameter that is fitted with an aluminum mounting base at the root and with a plastic, 3D printed PLA spool end cap at the tip. The spool cap is epoxied into the mandrel at the tip, and the mandrel base is epoxied into the aluminum plate. The mandrel was sized so that the height of the mandrel extending past the 6 mm (¼″) thick aluminum plate was 300 mm as illustrated in FIG. 21.

The plastic spool cap and the aluminum base have several functions. The aluminum plate has a mounting pattern for both the winding machine and vibration table. Both of the mandrel end features serve as spool flanges to ensure membrane alignment during winding and prevent excess axial shifts of the membrane due to slip. The spool cap also incorporates features to support the tip end of the mandrel during winding operations. Additionally, both end features also prevent ovalization of the tube during winding or vibration. Finally, the plastic spool cap also provides a tip mass to reduce the resonant frequency of the assembly to a range that can be more finely resolved by the measurement system and leads to more economical computation time for later simulations.

### Test Sample Assembly Procedure and Preload Measurement

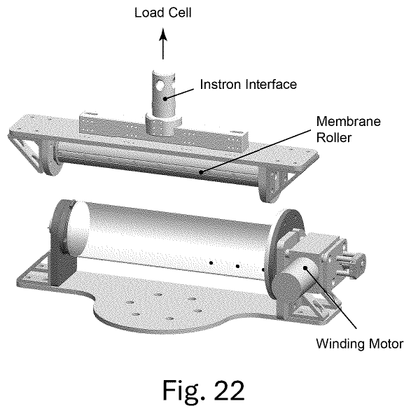

A constant tension winding machine was built to perform the winding-rewinding operation. The machine consists of a center winding process that is driven by the rotation of the mandrel, where Kapton film is wound from the membrane roller onto the mandrel (FIG. 22). Both the mandrel and membrane roller are driven by brushed DC motors. The central motor is a GW600 DC 12V 10 RPM motor with an integrated worm gear train, rated for approximately 12 Nm torque. The motor powering the membrane roller is a Maxon DCX22S motor with an integrated Maxon GPX22UP 186:1 planetary gearhead. The central winding motor operates under constant voltage (speed), and the membrane roller operates under constant current (torque). For this winding setup, the membrane roller is being back driven, where the torque of the central winding motor overcomes the winding motor to unspool membrane from the roller with tension.

Before winding on the Kapton membrane, circular reference tracking targets are fixed to the mandrel surface at several locations near the base of the mandrel (

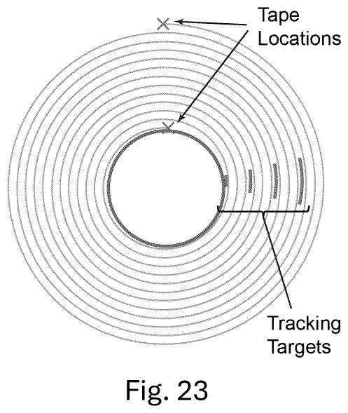

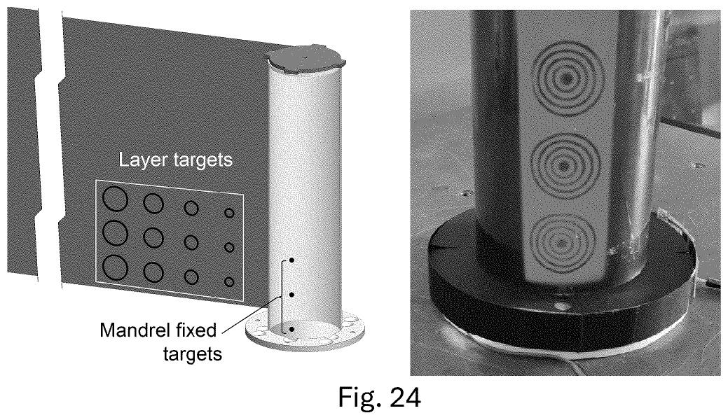

To start the winding process, one end of the membrane is attached to the mandrel using tape (FIG. 23), and the membrane is then wound over the initial reference targets. During winding, circular ring targets are placed on subsequent alternating layers, concentric to the reference targets (FIG. 24). After coiling is complete, the free end of the membrane is fixed to the outer surface of the roll with tape.

The tracking targets are made of masking tape and are visible through the transparent mandrel and Kapton membrane when the wound roll is internally illuminated in FIG. 24. The internal surface of the mandrel was covered with aluminized Mylar, which creates a mirrored surface that focuses the internal illumination onto a narrow section of the test sample containing the line of targets. This is done in order to increase signal strength during high speed camera measurements.

Initially, an attempt was made to directly measure the state of stress of the roll using Tekscan A-201 FSR flexible pressure sensors inserted at the beginning of winding at the mandrel interface, under the first layer. Force Sensitive Resistors (FSR) are piezo-resistive elements that convert changes in force to changes in resistance. The changes in resistance are converted to a voltage using devices such as the voltage divider analog circuit module from the Tekscan FlexiForce Prototyping Kit in order to be read by a DAQ device. These sensors have seen successful use in measuring interlayer stresses in wound roll in previous studies.

However, it was observed that the response of the sensor was highly sensitive to the stiffness of the interface being compressed. Because different interface materials, especially more compliant ones, can affect results, it is generally recommended to calibrate the FSR and measurement system with setups that emulate the stiffnesses that will be experienced by the sensor in the measurement application [63]. In this particular case, the measured voltage and applied load calibration using an Instron testing machine did not appear to be consistent when the sensors were used on the much more compliant interface of the hollow cylindrical mandrel-Kapton layer system. Unfortunately, attaining in situ calibration within the wound roll poses a challenge, given the absence of a clear method that avoids interfering with the measurement.

The responsiveness of the sensor was capable of distinguishing between different preload levels in a relative sense, but consistent knowledge of the absolute preload was not obtainable in this setup. There are other methods of measuring interlayer stresses of a wound roll, both indirect and direct, such as pull tabs, roll hardness testers, and acoustic testing, however these were deemed infeasible for the low number of layers in this particular experiment.

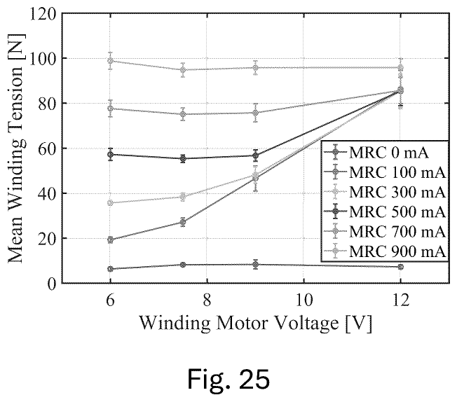

As such, the winding tension was directly monitored using an in-line force sensing load cell. In order to achieve both approximately constant tension over the entire winding process and maximum tension differentiation between membrane roller current setpoints, the central winding motor voltage was set to 6 V. The membrane roller motor voltage was held constant at 10 V, and the winding current was varied from 0 mA to 1000 mA. For the 0 mA case, the membrane roller was not only unpowered, but was also unplugged, which removed the braking effect due to back EMF. Here, only a minimal amount of load is applied to the membrane through back driving the membrane motors' gearbox. FIG. 25 shows the winding motor study that was used to select these operating points. Setting the winding motor voltage to 6V achieves the best performance in delineating the measured in line tension between roller current settings.

The coiled roll was assembled using a range of different membrane roller currents using this winding process, and resulted are parameterized by the measured winding tension.

### Vibration Experiment Setup and Test Procedure

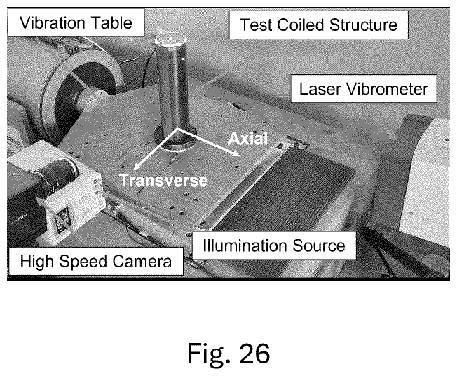

The preloaded, coiled assembly was then placed on a vibration table, and a retro-reflective tracking marker was placed at the tip of the assembled roll as well as on the shaker head as depicted in FIG. 26. The retroreflective tracking markers were used in concert with a Polytec PSV-500 Laser Scanning Vibrometer, which provided a non-contact measurement method that was preferable over accelerometers to avoid affecting the vibration response.

### Vibration Response Experiment Procedure

The vibrometer was used to control the vibration table in order to study the behavior of the wound roll under different excitation profiles. Sine sweep was the primary excitation profile used for measurement of wound roll response and performance characterization using the metrics of damping and resonant frequency. The other profiles used in this experiment, including sine dwell, random, and shock, are used because they reflect more realistic loading cases. The sweep is run from 5 to 300 Hz for a 45 second duration. The chosen frequency range was selected to encompass the resonant frequency of the mandrel by itself (fn, mandrel≈150 Hz), and any potential frequency shifts with winding tension indicated in the previous section. Notably, this corresponds to a relatively fast sweep rate (R≈8 oct/min), which initially raised some concerns about affecting the modal response.

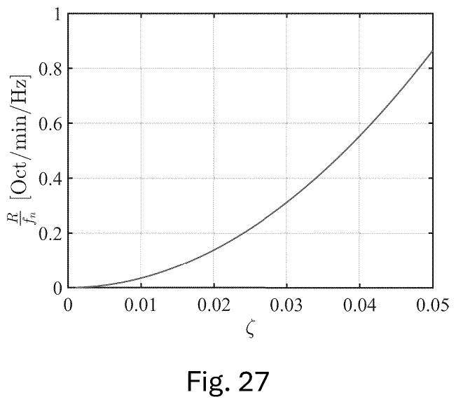

In sine sweep vibration simulations of single degree of freedom (1-DoF) models, the sweep rate is observed to potentially impact estimates of the resonant frequency and damping, causing them to deviate from the steady state response [64]. Experimentally, the effect of sweep rate was explored, but did not appear to impact estimates significantly. An explanation for this observation is that sufficiently damped systems are relatively insensitive to sweep rate. FIG. 27 demonstrates the permissible exponential sweep rate, normalized by the resonant frequency, for the response of a 1-DoF system to approach 90% of the expected steady state response as a function of the damping in the system. FIG. 27 indicates that, even for modest levels of damping, if the resonant frequency is sufficiently high, the system can support a relatively high sweep rate without significantly affecting the response.

A more stringent constraint that determined the sweep rate for this experiment was the sampling duration set by two settings on the Polytec Vibrometer software: the number of FFT lines and measurement bandwidth. The selected sweep rate was a compromise to get as high of an FFT sampling resolution possible to get good frequency response resolution while ensuring that the sampling duration covered the entire excitation duration. As a contingency, the vibration responses obtained from non-harmonic loading types like random and shock provide additional data, unaffected by sweep rate, to corroborate observed trends and behaviors observed under sinusoidal loading.

In all test cases, the acceleration spectrum of the tip tracking marker and the vibration table shaker head marker are recorded in order to provide acceleration transmissibility response curves. Damping is estimated from the experimental transmissibility spectrum by using the half-power bandwidth method on the first peak acceleration response, which corresponds to the natural frequency of the wound configuration:

$$ζ = \frac{1}{2} \frac{Δ {f}_{3 d B}}{{f}_{n}}$$

Before each test, a low level sine sweep is performed to characterize the initial behavior of the wound roll. This characterization is repeated at the end of testing to ensure that no damage has occurred to the roll. In general, outside of cases where damage to the test sample was confirmed, no significant variation between pre-testing and post-testing responses was observed.

### Vibration Experiment Results Vibration Response in No-Slip Regime

The fundamental frequency of the wound roll assembled under different winding tensions was recorded for a range of excitation levels using random excitation. In this set of experiments, random excitation was selected for efficiency in quickly measuring the response of a test configuration under varying excitation levels and in order to make consistent comparisons. Random vibration excites all modes within the selected spectrum simultaneously, eliminating the need to perform a sine sweep for each tension and excitation level configuration to determine whether a resonant frequency shift had occurred. As amplitudes are also random, the responses are subsequently time-averaged to obtain the mean response before comparison.

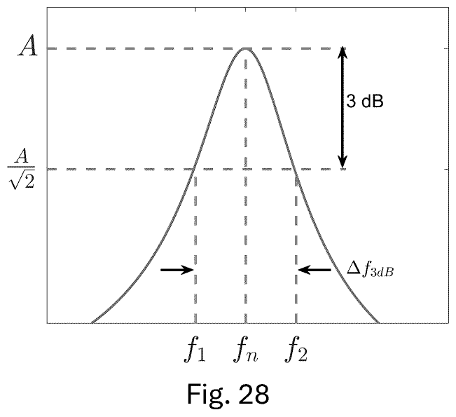

The recorded resonant frequency is plotted against the measured tip acceleration and is shown in FIG. 28. In addition, the vibration response of the mandrel by itself, excluding the wound roll, is depicted. The figure includes an overlay of the coiled-stiff FEA model's predictions in green, specifically for frequencies surpassing the mandrel-only response.

For this study, two sets of wound roll response data are presented in FIG. 28, corresponding to different interlayer surface treatments. The first corresponds to bare, uncoated Kapton, which is considered the baseline case. The second set of data corresponds to a Kapton roll that has been treated with temporary spray adhesive (Sulky KK2000) to increase the coefficient of friction, which is intended to illustrate the effect of varying the interlayer contact properties. The investigation of treated Kapton is only performed in this set of experiments. All other investigations discussed in later sections study untreated Kapton.

Looking at the mandrel-only system, note that the stiffness is approximately constant, irrespective of excitation level. This demonstrates that the mandrel fixture will provide a useful baseline comparison, and any deviation in vibration behavior results from the contribution of the wound roll.

For the wound roll data with uncoated Kapton, the resonant frequency of the wound roll increases with winding tension. Furthermore, the span of measured resonant frequencies is well within the expected range predicted from the coiled-stiff assumption, demonstrating the utility of the FEA model. The shifts in resonant frequency indicate that the roll can provide meaningful adjustment to the effective stiffness of the overall assembly with winding tension.

While the mandrel-only resonant frequency was invariant with the excitation level, the coil-mandrel assembly natural frequency tends to decrease with increasing acceleration. However, increasing winding tension reduces the sensitivity to the excitation level. Despite the reduction in effective stiffness with higher excitation, the assemblies wound at larger tensions maintain a higher fundamental frequency than the unloaded mandrel by itself, indicating that the coil windings are providing structural support. This is in contrast to the most loosely wound case, where the resonant frequency similarly started above the mandrel-only response. However, for sufficiently large acceleration, the assembly stiffness decreases below the mandrel-only level, behaving more like an added mass. The most probable explanation for the response variation is the degree of interlayer slip, where the most loosely wound case studied here experiences greater extents of slip for the same excitation levels.

For the wound roll data with modified contact properties, the response differentiation between winding tension variation is decreased. For the same range of winding preload and excitation levels, the wound roll data with treated Kapton demonstrates stiffer responses, characterized by higher frequencies. Additionally, there appears to be a saturation effect, where there is no significant variation in response after a critical preload level. The maximum recorded resonant frequency of the test cases with increased interlayer friction remains within the predicted frequency range of the coiled-stiff model. This indicates that the isotropic limit used in the coiled-stiff FEA model is a useful upper bound.

The results of this experiment suggest that the simplification of treating a tightly wound roll as a continuous solid is a useful approximation, but its applicability may be limited when excitation levels are sufficiently high to cause significant interlayer slip. The critical load level may be controlled by modifying the winding tension or the contact properties between layers. Moreover, this experiment validates the idea that wound rolls can provide substantial stiffness modification with winding tension.

### Vibration Response in Slip Regimes

### Sine Sweep: Vibration Response Characterization

For the next set of experiments, the vibration response of wound rolls in slipping regimes is studied to assess damping characteristics. Here, an exponential sine sweep is used to obtain the frequency response spectrum. For this set of tests, the excitation amplitude is fixed and the target input acceleration at base was chosen to be 5 m/s2 (approximately 0.5g), which is a typical amplitude for experimental modal characterization.

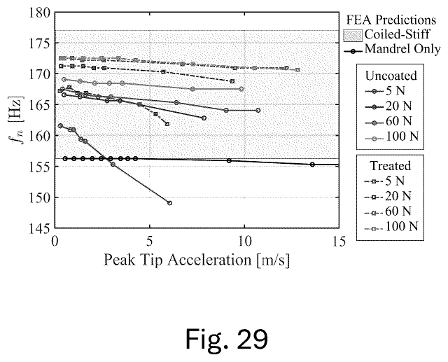

The frequency responses of the wound roll with different winding tensions are shown in FIG. 29A. The natural frequency, fn and damping estimate, ζ, are extracted from each curve. The damping of the wound roll plotted against the measured natural frequency of the wound roll is shown in FIG. 29B. The response and damping of the mandrel by itself is also shown in these figures.

From these plots, there appears to be an approximately bimodal response between ‘loosely’ wound and ‘tightly’ cases for the range of winding tensions studied. For low winding tensions, the response curves demonstrate a positive skew, which reduces as tension increases. On average, significant variations in winding tension yield clearly distinguishable responses. However, it is important to acknowledge that there is variability in discerning responses by winding tension magnitude. As illustrated by the scatter in FIG. 29B, for the same apparent winding tension, the vibration response is not necessarily consistent, and variations are not necessarily monotonic with winding tension. Additionally, with the specified sample preparation procedure and excitation level, the vibration response appears to tend towards saturation at either extremes of winding tension levels. Regardless of how loosely the structure is wound below approximately 20 N winding tension, there is no additional variation in response. Similarly, for tightly wound structures, after approximately 50 N tension, no further significant variation in response is achieved with increasing tension.

A possible explanation for the response saturation is that the degree of interlayer slip for the tested configurations has reached a limiting value. At a constant excitation level for these test cases, the extent of interlayer slip can only propagate so far when wound loosely or be constrained so much when wound tightly. This idea is explored in later experiments when a larger range of excitation levels is considered. Another likely explanation is the variability in the winding process during the assembly of test samples and challenges in precisely controlling incremental changes in winding tension from one test to another. Despite this limitation, the difference in stiffness, amplitude of response, and damping are large enough between ‘loosely wound’ and ‘tightly’ wound configurations that conclusive statements can be drawn.

For configurations wound at lower winding tensions, the assembly exhibits reduced stiffness and significantly increased damping relative to the response of the mandrel by itself. The penalty in reduced stiffness in exchange for increased in damping observed in the highest damped configurations is comparatively small for this assembly, as the observed natural frequency was reduced by only approximately 10%. Conversely, more tightly wound cases demonstrate increased stiffness and comparatively less damping than more loosely wound rolls. An approximately 5-10% increase in resonant frequency was observed for the stiffest configurations observed.

In general, increasing the winding tension during the coiling process results in an overall increased stiffness for the final wound roll, but corresponds with decreasing damping. However, regardless of the winding tension, the addition of the wound roll has increased the overall damping of the assembly. The estimated range of critical damping for the wound roll assembly ranges between 1% and 5%, marking an increase from the mandrel-only result of approximately 0.5%. These results confirm the potential of the wound roll damping concept, which utilizes the wound roll as an energy dissipation mechanism.

Random Vibration: Performance Variation with Excitation Level

The vibration response of a wound roll is determined by the coupled interactions between the preload, structure, and excitation. While there were challenges in controlling preload increments to achieve smooth variation, as described in the previous section, the excitation levels could be continuously varied. This provides an opportunity to not only examine the sensitivity of the response to changes in excitation level but also determine whether the bimodal response observed previously is a real effect. In this set of experiments, the excitation profile reverts to random vibration, with the focus now on investigating a significantly broader range of excitation levels.

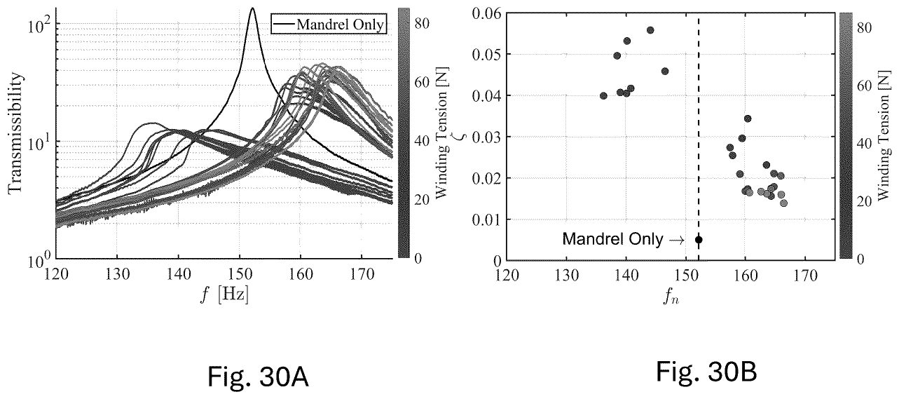

FIG. 30 shows the vibration response variation between three test cases for varying levels of random vibration excitation: the mandrel by itself, and the wound roll for two levels of winding tension: 20 N and 60 N. In each of the plots in FIG. 30, the excitation magnitude labeling is normalized by the maximum level. As previously mentioned, responses to random excitation are obtained by time-averaging to establish the mean response before conducting comparisons. Note that, unlike with the sine sweep data, the vibration responses with excitation level do not exhibit the bimodal grouping and have a comparatively smoother transition with excitation level. This indicates that the bimodal response distribution observed in the sine sweep data is most likely an artifact of the sample preparation process, and not a physical mechanism of wound roll damping.

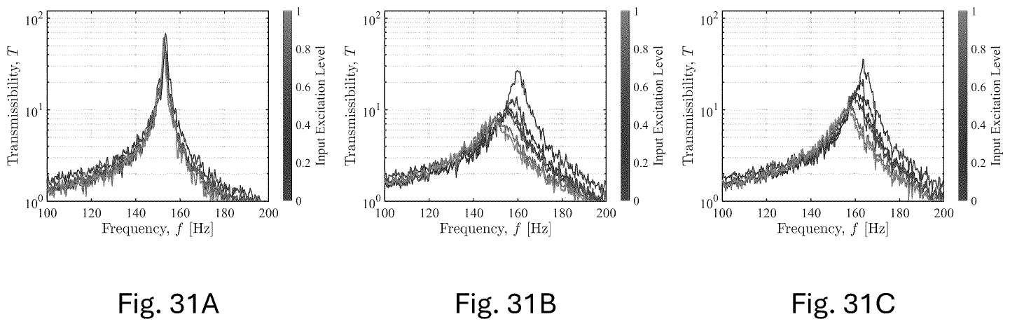

The damping ratios are extracted and plotted versus normalized excitation level in FIG. 31 to facilitate more straightforward comparisons. Note that these values are not meant to be compared with the damping estimates reported from sine sweeps, which is typically how these values are conventionally obtained. Instead, they are utilized as an accessible metric that captures the amplitude and width of response peaks for relative comparisons.

FIG. 30A shows the mandrel-only response. Here, transmissibility is observed to be invariant to excitation amplitude. This demonstrates that any subsequent variations in response after including the wound roll are not attributed to the mandrel.

FIG. 30B shows a wound roll test case for the lowest winding tension in this experiment set. The wound roll vibration performance is consistent with previous findings; regardless of excitation amplitude, the wound roll shows decreased response and, therefore, higher damping in all cases relative to the mandrel-only response. As the excitation level increases, the resonant frequency of the wound roll decreases, and the damping level increases, as demonstrated by the positive slope in the damping response depicted in FIG. 31. This indicates a discriminatory, self-scaling feature of this damping concept. For low amplitudes of excitation, the wound roll exhibits a stiffer response to loading. As the excitation level increases, more layers within the roll slip, which increases dissipation and results in higher damping. This added damping is achieved at a relatively minimal cost, as the resonant frequency undergoes only a marginal change, i.e., approximately 5%.

FIG. 30C illustrates how the response varies with increasing winding tension, which further substantiates that the observed phenomena result from the influence of interlayer slip within the coil. Similar to the lower tension case, the wound roll still demonstrates higher damping than the mandrel alone, even with higher winding tension. However, as expected, lower damping is achieved and the range of resonant frequencies is higher, indicating that the higher tension winding demonstrates a stiffer response due to reduced slip.

### Shock Loading: Performance Under Impulsive Loads

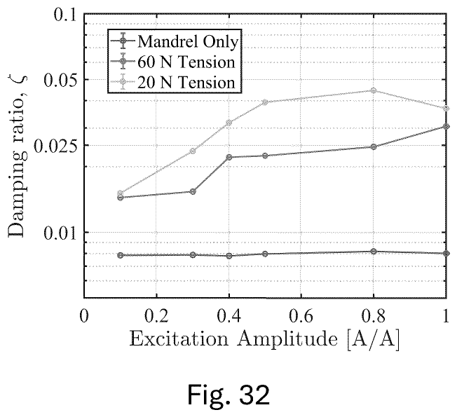

The final excitation profile in this set of experiments is shock loading. Some traditional damping concepts draw criticism for their inability to respond to impulsive loading without response delay or have loading rate-dependent behavior, which may lead to the direct transmission of loads. Therefore, the aim of this experiment is to assess the performance of this concept under shock excitation, which subjects the wound roll to impulsive, high loading rates. The shock profile used in this study was extracted from a spacecraft qualification test campaign and is shown in FIG. 32 for completeness. Nominally, this profile is intended to specify excitation levels for frequency content up to 5000 Hz, but the primary objective of this profile is simply to subject the test sample to impulsive loads, so no effort is made to ensure the table response matches the original shock response spectrum. This profile was normalized into a voltage signal, and then passed into the vibration table controller.

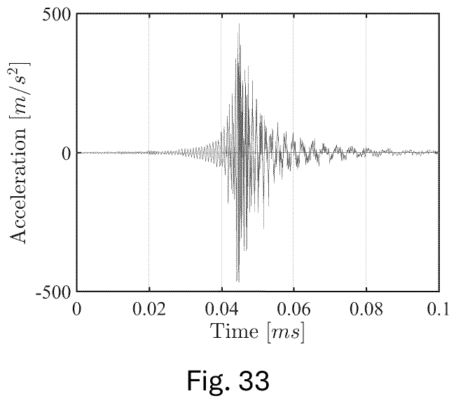

FIG. 33 shows the variation in wound roll response to shock excitation. Immediately apparent is the difference in damping between the mandrel-only case and the wound roll cases. For the mandrel-only case, low damping is evident as indicated by the response exhibiting the highest amplitude and the slowest decay rate, where the mandrel exhibits ringing for an extended duration. This is in contrast with the wound roll test cases, where the response decays much more quickly.

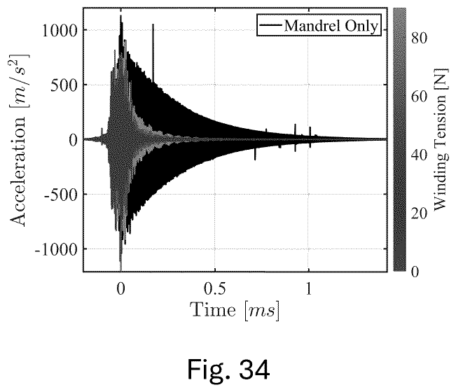

While one might be tempted to attempt to calculate the damping ratio from this data using the logarithmic decrement, the nature of the data does not lend itself well to this technique. For the mandrel-only response, the logarithmic decrement technique is easy to calculate because there is a single dominant frequency, and the exponentially decaying envelope is well-defined and consistent. However, for the wound roll dataset, there are numerous spurious signals that make defining a consistent decay envelope difficult and multiple frequency components with no dominant peak frequency. Instead, the frequency responses can be extracted using the FFT as shown in FIG. 34. Note that each of these curves is the averaged response obtained from three separate trials.

Note that the overall shape of the wound roll responses obtained from shock loading are significantly different from those obtained from the sine sweep experiments. The disparity between the frequency responses obtained from shock data and sine sweep data can be attributed to the distinct nature of these input signals. Shock data subjects the test sample to impulsive force inputs, leading to a frequency response that reflects the system's response to loading rate. In contrast, sine sweep data involves a continuous and smoothly varying input signal that sweeps through a range of frequencies, providing a more comprehensive view of the system's behavior across different frequency components. The abrupt nature of shocks can excite specific resonances and dynamic characteristics of the system that may not be as prominent or easily discernible during a sine sweep. Additionally, shock events may induce nonlinear behavior in the system, further contributing to differences in the frequency response compared to the linear and continuous excitation provided by a sine sweep.

The responses in FIG. 34 generally demonstrate behaviors consistent with the previous excitation profile experiments. As winding tension increases, the frequency of the peak response increases, indicating stiffer behavior that can exceed the stiffness of the unloaded mandrel for sufficiently high tension. Additionally, irrespective of the winding tension, the presence of the wound roll damper consistently reduces the vibration response where all wound roll responses show lower tip response than the mandrel-only case.

A notable observation is that the configuration with the lowest winding tension does not necessarily exhibit the most damped response. An indication of this property was potentially hinted at in the sine sweep data, where the response with the lowest resonant frequency did not have the lowest peak response in the dataset. This is an indication that there exists an optimal value of winding tension for peak damping, which is a known property of friction dampers, where frictional energy dissipation is optimizable. Further discussion of this topic will be addressed in upcoming sections dedicated to FEA, where the magnitude of energy dissipation can be extracted directly.

### Interlayer Slip Measurement Experiment Layer Slip Measurement Procedure

Having now examined the vibration response and performance of the wound roll damper, the objective of the remaining experiments focus on confirming the underlying mechanism for energy dissipation is, in fact, layer slip. In order to demonstrate this, the approach is to correlate damping levels with direct measurements of layer slip to pinpoint locations exhibiting the highest slip magnitude.

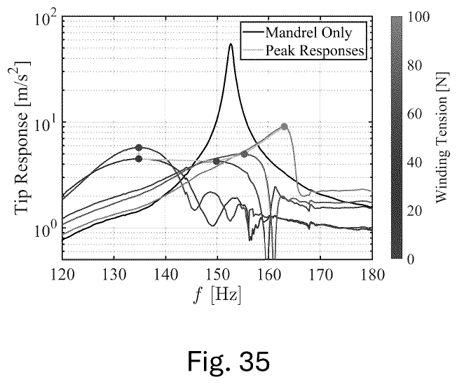

This experiment is performed for two test cases with different winding tensions, using a sine dwell at the resonant frequency of each configuration. During each test, an internal illumination source mounted underneath the test sample is turned on, allowing a high speed camera to record the tracking targets during the vibration experiment at 2000 fps. The slip measurement for each of the two tension levels tested is performed twice: once with the camera viewing direction aligned axially to the excitation direction and once in the transverse direction. Axial measurement refers to the surface with the normal aligned in the excitation direction, while transverse measurement applies to surfaces with the normal oriented orthogonally to the excitation direction (FIG. 35). Because the tracking targets are placed only along one longitudinal line along the test sample to keep the targets centered in the camera image frame to minimize the effect of distortion, the wound roll and the high speed camera position must be rotated for each viewing direction.

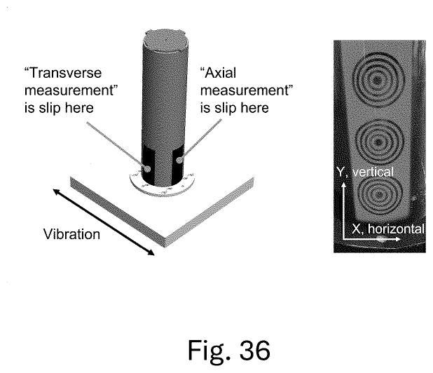

Images from the high speed camera were exported onto a personal computer and processed using MATLAB. Each frame was thresholded to create a grayscale image of binary values. The targets in the processed image are identified by the number of connected pixels, as well as their circularity and diameter. Once successfully identified, the centroids of each target, measured in the image coordinate frame (x, y), were stored. A centroid based tracking scheme was found to be more robust compared to an edge detection scheme, which was highly sensitive to imaging noise resulting from high frame rate imaging that measured low signal-to-noise due to lower exposure time. FIG. 36 shows an example processed image that indicates the accuracy of the centroid tracking scheme for one particular image.

The targets at a given longitudinal position are denoted as Group i. The targets on a given layer are denoted with Layer j. For a given target Group i, subtracting the position of the reference target, (xr, yr)i from the position of the layer targets (x, y) j eliminates the contribution of the mandrel movement. The resultant is the slip of layer j, (sx, sy) j, relative to the mandrel:

$${( {s}_{x} , {s}_{y} )}_{i}^{j} = {( {x}_{r} , {y}_{r} )}_{i} - {( x , y )}_{i}^{j}$$

Interlayer slip can then be computed by taking the difference between layers:

$${( {s}_{x} , {s}_{y} )}_{i}^{{j}_{1} - {j}_{2}} = {( {s}_{x} , {s}_{y} )}_{i}^{{j}_{1}} - {( {s}_{x} , {s}_{y} )}_{i}^{{j}_{2}}$$

Note that the slip calculations are performed in the time domain and the units are in pixels.

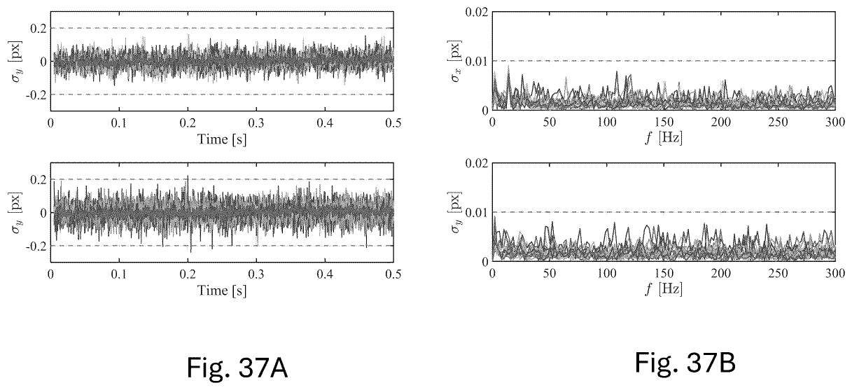

The noise floor of the measurement and processing chain was evaluated by applying the entire procedure to the sample measured at rest. High frequency noise present in the statically measured centroids in the time domain (FIG. 37A), motivated performing analysis in the frequency domain and only considering a neighborhood around the excitation frequency that was tested experimentally (FIG. 37B).

This was done by taking the Fourier Transform of the time domain signals, which was a preferred method over directly filtering or smoothing the time domain data to avoid impacting the slip measurement. From this, the maximum uncertainty in the position of the targets measured statically in the frequency band of interest was found to be δ=max(δx)=max(δy)≈0.01 px. Since slip is calculated from the difference of two uncertain measurements, the propagation of uncertainty results in a total slip noise floor of δs=√2δ≈0.02 px. Slip magnitudes at least δs above the noise floor would be considered as a real signal, whereas values below this threshold would be considered indistinguishable from the static, no slip condition. As a result, after first performing slip calculations in the time domain, the results are converted into the frequency domain for evaluation. The dimensions of the targets are known and can be used to convert from pixel units to mm. The conversion is approximately 0.1 mm/px.

### Slip Experiment Results

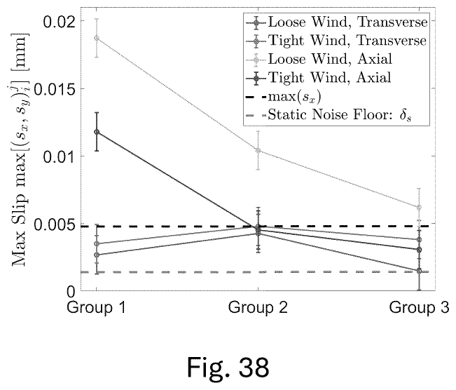

FIG. 38 shows an overview of all slip measurements, where the maximum, mandrel relative slip, in any direction (x, y) at any layer, max[(sx, sy) j], is plotted against
the target groupings for both axial and transverse measurements. In this figure, the error bar corresponds to the uncertainty of the measurement, δs. The red dashed line in this plot corresponds to the noise floor. The black dashed line shows the maximum slip, considering only the x direction, sx. This is included to gauge the relative magnitudes between sx and sy.

In examining the data, the scale of slip is noted to be well under 1 mm in amplitude, which is less than 0.01% of the length of the wound roll assembly. This experiment is conducted at the natural frequency of the system, representing conditions where maximum stresses are anticipated. Consequently, it is expected to yield among the largest slip amplitudes among the experiments conducted. This measurement indicates that only a relatively small amount of slip is necessary to achieve the damping performances observed. With the combined effects of the spool caps and winding start and end terminations, no significant large scale shifts in the wound roll layers were observed, despite sustained loading and regardless of the periodicity of the loading. This observation indicates that the wound roll damping concept can operate effectively without requiring substantial stroke.

Comparing now the directions, slip measured on the transverse face is observed to be smaller than in the axial face. Additionally, in the transverse direction of measurement, there is no clear difference between the loose and tight winding cases: the curves coincide within the uncertainty of the measurement. In the axial direction of measurement, there is an unambiguous delineation between tight winding and loose winding, as seen in the difference of the slip magnitudes. Therefore, attention is focused on the axial measurements and the components of mandrel relative slip (sx, sy) can be examined separately.

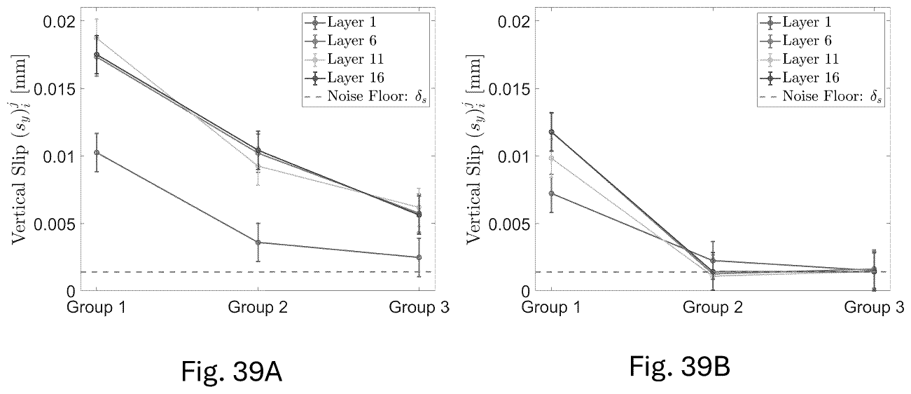

In the axial direction, the vertical slip, sy, is larger than the horizontal slip, sx. This can be seen in FIG. 38, where the largest horizontal slip recorded does not exceed 0.005 mm. Thus, only the vertical slip data for the axial measurement direction is reported in FIG. 39 for both winding cases.

FIGS. 39A and 39B show the vertical slip measurements, sy, for each winding tension case, delineated by grouping as well as by layer. Here, the loosely wound case demonstrates larger slip magnitudes than the tightly wound case. Maximum slip, in either case, occurs towards the base of structure (Group 1) and falls off further away from the base, consistent with previous estimations. Comparing the magnitude of slip by layer, the maximum degree of slip does not occur at Layer 1, which does not match the theoretical prediction. However, a possible explanation for this discrepancy is that the leading edge of the 1st layer was fixed to the mandrel with tape at the beginning of winding, and so there is an additional constraint on this layer.

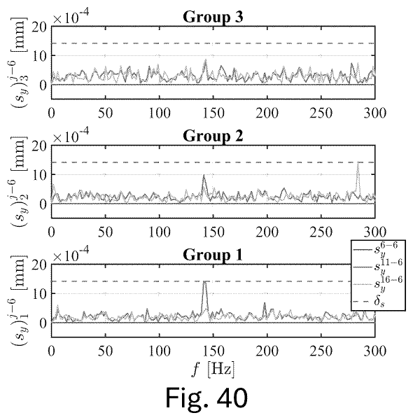

Examining FIG. 39A, the mandrel relative slip magnitude curves for Layers 6, 11, and 16 coincide. This suggests that after a certain layer, between Layer ₁ and Layer 6, there is no more relative movement between layers. This fact is clearly evident when considering the interlayer slip, (sx, sy) j1−j2, instead of the mandrel relative slip, as shown in FIG. 40. The curves in this figure are obtained by subtracting the centroid position of Layer 6 from the centroid positions of all subsequent layers in the time domain, and then taking the Fourier Transform.

FIG. 40 demonstrates that the measured slip relative to Layer 6 is indistinguishable from the static noise floor, which indicates that there is no appreciable interlayer slip beyond Layer 6. This result is consistent with the findings in the previous section, which indicated that the largest shear stress components for a wound roll undergoing base excitation were the σrz shear stresses in axis to the excitation direction. The location of these stresses was at the base of the structure, propagating only a small radial distance away from the innermost layer. This experiment confirms that due to the bending vibration mode of the structure, the inner layers towards the bottom of the roll, in axis of vibration, have the largest effect on dissipation for the wound roll damper concept due to slipping in the vertical direction.

The vibration performance of the wound roll damping concept was determined using a range of different excitation profiles. The results indicate that this concept is a relative motion device; regardless of the loading spectra or rate, if the excitation induces stresses that exceeds the shear capacity, slip occurs and leads to increased damping. This indicates that this concept works for any waveform or frequency and works for all resonances.

The concept was demonstrated to exhibit sensitivity only to excitation amplitude, indicating discriminatory, self-scaling behavior. It “activates” only when stresses reach a sufficiently high level and inherently scales with loading through the geometry of coiling. As loads increase, the propagation of slip through coiled layers and axial extents also increases, resulting in enhanced damping. Additionally, this scheme was proven to be an integral vibration damping and stiffness scheme that is tuneable with winding tension. Although, similar to other damping concepts, there remains an adverse relationship between damping and stiffness, the associated decrease in damping for increased stiffness is comparatively low.

The slip measurement experiment was able to confirm the “active” regions in the wound roll damping concept. These are the regions where slip occurs during vibration and are responsible for the energy dissipation mechanism. High speed camera measurements determined that the vibration mode of the structure dictates the location of the actively slipping regions. For the case of a cantilevered, cylindrical structure with a wound roll damper, subject to base excitation, interlayer slip initiates at the base of the roll from the inner layers. This result indicates that, while the entire coiling form factor plays a role in the stiffness of the assembly, only a limited region may participate in the damping process for a given excitation loading level. This result is salient as it identifies the critical regions for focus when considering techniques to engineer contact properties to control slip for either the purpose of adjusting damping or protecting sensitive surfaces.

### Finite Element Simulation of Wound Roll Damping

Following the experimental studies, a finite-element analysis (FEA) is performed in order to build a simulation model that correlates with the variations in damping and locations of slip observed in the experiments. The aim is to build the simplest model capable of encapsulating both the quantitative and qualitative features observed in experiments. Even qualitative agreement between experiments and simulation would provide a starting point for demonstrating an understanding of the key parameters for this frictional damping mechanism.

Because the simulation now needs to provide damping estimates, the model consisting of a homogenized coil solid that is bonded to the mandrel can no longer be used, and discrete layers are required to model the contact interfaces for slip. Friction is a dynamic and time-dependent phenomenon where the frictional forces between surfaces can vary due to factors such as changes in relative motion and applied loading. This variability can lead to dynamic effects such as stick-slip behavior, hysteresis, and other temporally varying responses. As such, obtaining an accurate model of the vibration response and damping from Coulomb friction can only be achieved with time-domain simulations.

The simulation is conducted on a simplified, 3D representation of a wound roll, which consists of several concentric, cylindrical shells, which approximate coiled layers around a mandrel. The simulation uses geometry and properties derived from the experimental setup. The coil layers are preloaded against the elastic mandrel using a range of pressures, and a friction interaction is defined between all adjacent contact surfaces. Base excitation is then applied, both in the form of sine sweep and sine dwell. The simulation is integrated in time, and the tip and base accelerations are recorded for the sweep excitation to obtain the frequency response, while the contact status of all elements is recorded for the dwell excitation to identify the extents of slip. The simulated frequency response, corresponding damping values, and slip locations are then compared against the experimentally measured values.

### Wound Roll Damping FEA Simulation Setup and Simulation Procedure

The simulation is conducted on a simplified 3D representation of a wound roll that consists of several concentric, cylindrical shells, which approximates coiled layers around a mandrel. Similar to the experiment, the coiled structure is supported by an isotropic mandrel, fixed in a cantilevered configuration with a tip mass, m. The coiled structure is represented by n elastic layers placed around the mandrel, with the outermost layer preloaded with a pressure loading, or. The mandrel is defined by the length, L, outer radius, rm, and wall thickness, tm. The coiled structure has the same length as the mandrel and layer thickness, tl, which is scaled to have total thickness of all layers equivalent to the 25 Kapton layers in the experiment:

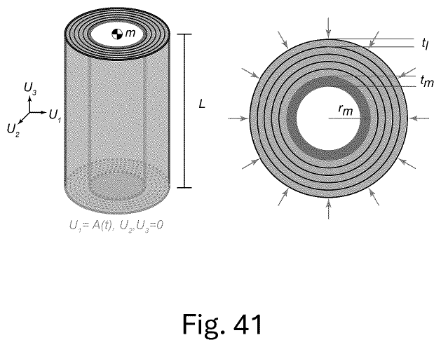

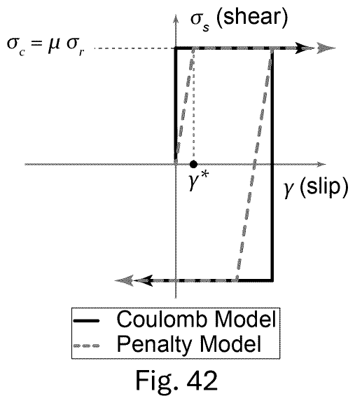

For this simulation, the geometry and properties used in the model are derived from the experimental setup. The coil layers were preloaded against the elastic mandrel using a range of pressures, and a friction interaction was defined between all adjacent contact surfaces. The contact interfaces between the coil and mandrel and adjacent coil layers are defined by a Coulomb-like, penalty friction model, where a small degree of elastic slip is allowed to help with convergence issues associated with the discontinuity of the unmodified Coulomb model (FIG. 42). The friction model is defined with coefficient of friction, μ, allowable elastic slip, γ*, hard contact, i.e., no penetration, and separation allowed. No other form of damping was included. The numerical damping associated with the default integration method for dynamic implicit contact simulations is observed to have negligible effect on the simulation response. This is further discussed in Appendix B. The mandrel was modeled using S4R shell elements and the coil layers were modeled with M3D4R membrane elements, which have no bending stiffness. The base of the coil was assumed to be bonded to the mandrel's base (FIG. 41).

The geometry and properties of the mandrel-coiled layers system as well as certain simulation parameters are shown in the tables below. These values were determined from a combination of datasheet properties, direct measurement, and correlation from indirect measurements. In particular, the modulus of the mandrel,

Em, was adjusted so that the resonant frequency of the ‘mandrel-only’ case matched experimental values of the corresponding ‘mandrel-only’ experiment. Similarly, the modulus of the Kapton layers, El, was tuned such that the resonant frequency of the simulation configuration with bonded coil layers (i.e., no slip), obtained from an eigenvalue frequency analysis, matched experimental values of the highest preload test case. In this manner, both the original underlying stiffness of the mandrel by itself and the limiting behavior of the highest preload experimental case were captured. Densities were calculated assuming the basic dimensions of the geometry (i.e., theoretically exact) to calculate the volume, and weighing the physical test articles to obtain the masses. Appendix A discusses the sensitivity of the simulation model to the value of the allowable elastic slip, γ*.

### Geometry and Simulation Parameters

| L (mm) | D (mm) | tₘ (mm) | tₗ (mm) | n | μ | γ* [m] |
|---|---|---|---|---|---|---|
| 300 | 80 | 1.5 | 25/n | 1-5 | 0.25 | 10⁻⁶ |

### Material Properties

| Eₘ (GPa) | ρₘ (kg/m³) | Eₗ (GPa) | ρₗ (kg/m³) | m (kg) |
|---|---|---|---|---|
| 2.7 | 1200 | 2.8 | 2000 | 0.05 |

The finite element software ABAQUS was used to determine the variation in the vibration response of the coil-mandrel assembly, as well as the locations of slip. First, a static analysis was performed to apply the initial preload of the coil layer(s) against the mandrel. In the next dynamic implicit step, the assembly was subjected to one of two acceleration base excitations for each study and time integration of the model response was carried out.

For the frequency response study, sinusoidal base excitation using a geometric chirp base acceleration excitation was applied. The geometric chip, also referred to as an exponential chirp, is performed over a reduced frequency range from 125 to 175 Hz at a constant 5 m/s2 amplitude with a 2 oct/min sweep rate. Despite finding no significant impact on modal response with varying sweep rates in experiments, a lower and more conventional sweep rate was chosen in simulations to err on the side of caution and ensure a conservative approach that does not affect modal response.

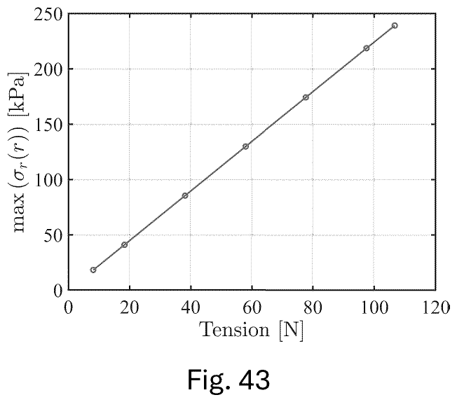

Fully modeling the dynamics and contact interactions between 25 layers for the experimental frequency sweep profile and duration was found to be computationally expensive. Therefore, using the results of Section 3.5, which indicated that the innermost layers are most significant for damping, the simulation models only one layer n=1 for the sweep studies. The range of preload stresses considered in simulation varies from 10 kPa to 300 kPa, which encompasses the range of experimentally applied radial stresses that are estimated using measured winding tensions with the stress models (FIG. 43).

Given the computational expense associated with the time domain simulations, aggressive mesh reduction was conducted. Here, due to computation cost, mesh convergence was investigated using the linear perturbation frequency method instead of time domain simulations. The acceptable mesh density criteria corresponded to the lowest mesh density that still maintained 99% of the converged value of fn. Generally, this corresponds to approximately 300 elements minimum for each shell, achieved by seeding the edges of the cylindrical shell with at least 30 mesh seed points on circular edges and 10 mesh seed points on axial edges.

The output of the sweep simulation reports the time history of the tip response of the coil-mandrel system, as well as the base input. The Fourier Transform of the tip response and base input, and subsequent ratio between the two provides the transmissibility response spectrum in the frequency domain, where the damping is estimated, again using the half-power bandwidth method.

For the layer slip study, a sine dwell base excitation was prescribed at the original ‘mandrel-only’ frequency, fn≈150 Hz. Here, the number of modeled layers is increased, n=5, in order to determine how many layers does slip propagate through during the vibration event. The simulation is run sufficiently long to reach steady state. In this simulation, each layer was individually preloaded with σr=200 Pa. Thus, the total preload on the innermost layer, against the mandrel interface, was 1 kPa. The contact status of the elements for all layers as well as the mandrel was recorded for the dwell excitation, with acceleration amplitudes ranging from 1-3g. The simulated frequency response, corresponding damping values, and slip locations from these two studies can be compared against the experimentally measured values.

### Results of Frequency Response Study

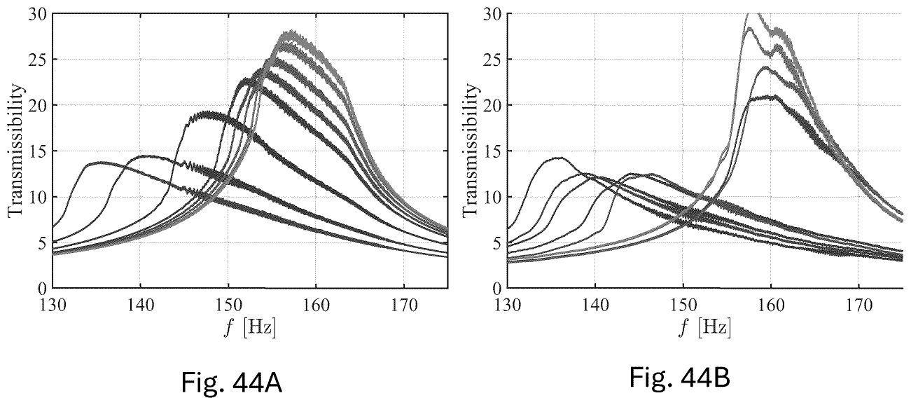

The simulated frequency responses for a variety of preloads are compared against a set of experimentally measured frequency responses with the closest equivalent measured preloads (FIG. 44). There is observed to be relatively good, agreement between the simplified FEA model and the experimental results.

Quantitatively, the simulation reports a span of resonant peaks and transmissibility amplitudes that are comparable to the experimentally measured results for a similar range of preloads. The response amplitude in both datasets decreases with decreasing preload, indicating that the looser winding exhibits increased energy dissipation and hence damping. For low preload cases, the experimental frequency response curves are positively skewed, which is likewise captured by the FEA model. This behavior is an indication of nonlinear damping or stiffness (softening).

The reduction in slip with higher preload results in decreased energy dissipation, causing the excitation response to increase compared to the lower winding tension cases. For both simulation and experiments, the reduction in slip further causes an increase in stiffness beyond the mandrel-only response, as seen with the highest preload responses where the resonant frequencies exceed that of the mandrel by itself (fn>150 Hz). This indicates that the FEA model successfully captures the stiffening effect where, for sufficiently high pretension, slip is suppressed, and the coiling form factor increases the effective wall thickness of the cylindrical sample, which causes the stiffer response observed.

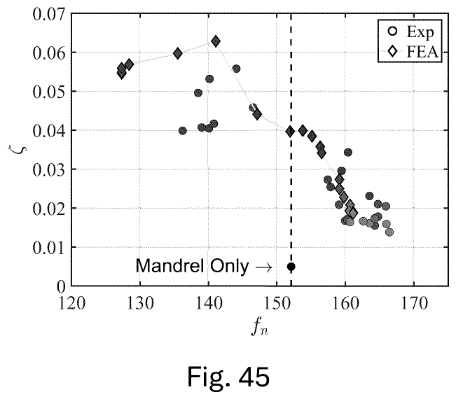

FIG. 45 plots the damping values extracted from the simulated responses with the previously shown experimental data. Both datasets exhibit similar trends between estimated damping and apparent stiffness with preload variation. The estimated damping from simulation has relatively good agreement with the experimentally observed range, with comparable magnitudes and frequency range spans with preload. This suggests that the underlying physics, namely the frictional slip damping and structure-dynamic loading interaction, has been captured by the simplified model. Noteworthy is that these results were achieved by simulating a single contact surface, further indicating that the innermost layer is the most important to energy dissipation in this concept.

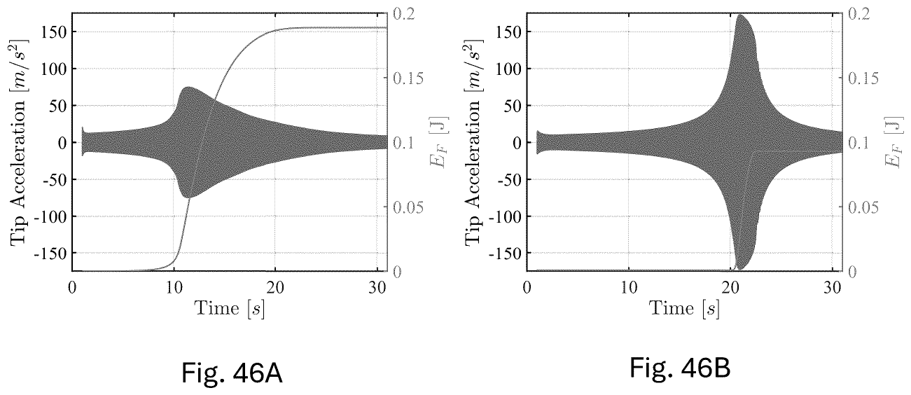

In simulation, the frictional energy dissipation, EF, can be directly extracted to determine if the response amplitude reduction of this concept is solely due to work done by friction. The highest rates of frictional energy dissipation during the sweep coincide with resonance, where the wound roll is subjected to the greatest loads. This is shown in FIG. 46 where cumulative work done by friction is plotted on top of the mandrel tip response during the sweep.

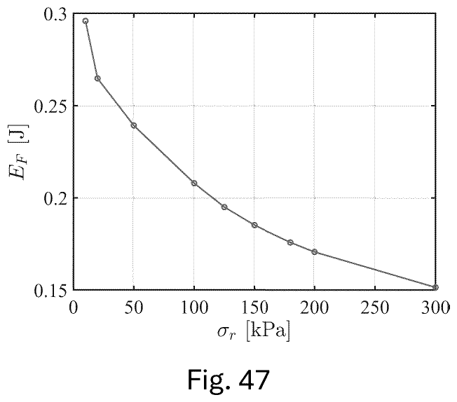

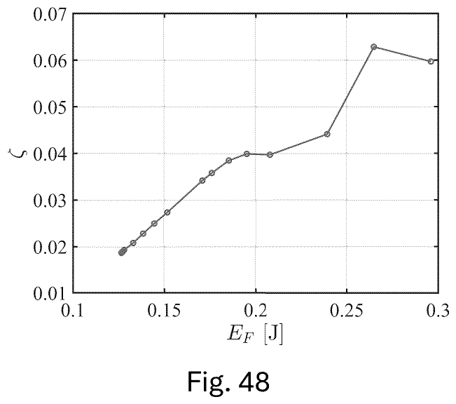

FIG. 47 plots the maximum frictional energy dissipation against the applied radial preload. Here, the energy dissipation is observed to decrease with increasing preload. Comparing just the total energy dissipated by friction alone against the damping estimate, the peak damping configuration does not necessarily coincide with the highest energy dissipation (FIG. 48). Regardless, in general, higher damping is positively correlated with EF. This result confirms that the response amplitude reduction in this damping concept is largely due to the friction dissipation mechanism.

### Results of Interlayer Slip Dwell Study

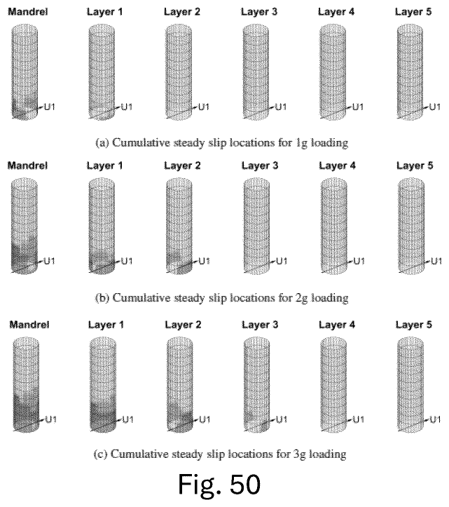

After obtaining agreement between the simplified FEA model and frequency response experiments, this model is reused to determine the locations of slip. Here, the number of layers is increased from the previous study from n=1 to n=5 in order to find where slip occurs and its propagation through the layers. This was done by tracking the contact status of all surfaces, which differentiates between slipping and sticking contact states. FIG. 50 depicts the cumulative, steady-state contact status for each layer across multiple loading amplitudes. Here, ‘cumulative’ meaning these plots depict locations of slip on each layer that was observed at any point during the simulation in red, whereas green denotes sticking, i.e., no slip, observed throughout the entire simulation. In this representation, the slip status of Layer i indicates slip with respect to Layer i+1.

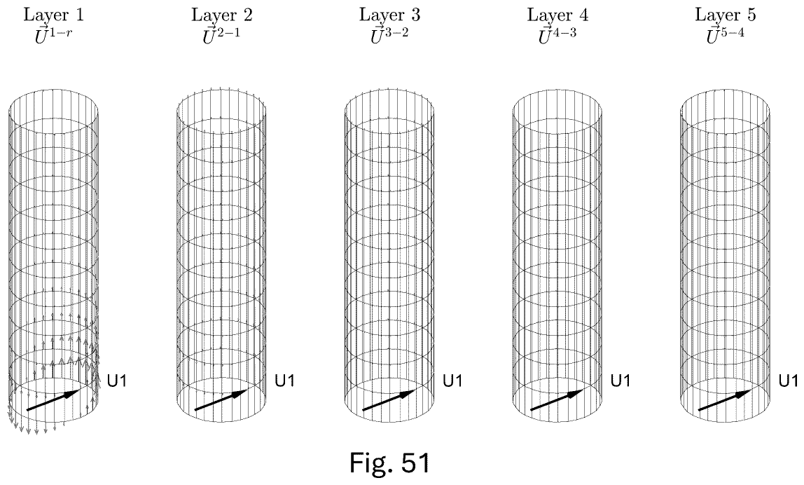

In FIG. 40A, the following behaviors are observed. First, the largest slip area occurs at the innermost interface, between the mandrel and Layer 1. Next, this largest patch of slip is vertical slip that occurs on the faces aligned with the U1 axis, which is the excitation axis. This can be seen in FIG. 51, which is a vector plot of the maximum relative displacements between Layer j1 and the preceding Layer j2=j1−1, which is denoted as UT j1−j2. And finally, after a certain layer, no slip is observed on any subsequent outer layers, as seen in both FIG. 50 and FIG. 51.

Keeping the friction and preload consistent, increasing the excitation level causes the area of cumulative slip to grow in the vertical direction as well as propagate through additional layers (FIG. 50). This indicates that larger excitation increases the extent of the layers that actively participate in energy dissipation, corroborating the previously stated assertion that the performance of the wound roll damper inherently scales with the excitation level.

Comparing the slip measurements obtained in simulation against experiment results, there is likewise observed to be good, qualitative agreement for the behavior trends in slip propagation, except for the location of maximum slip. In experiments, the location of maximum slip magnitude was not at the innermost layer of the roll. This is in contrast to both the simulated and theoretical prediction, where the maximum slip occurs at the innermost layer, between the 1st winding and the mandrel.

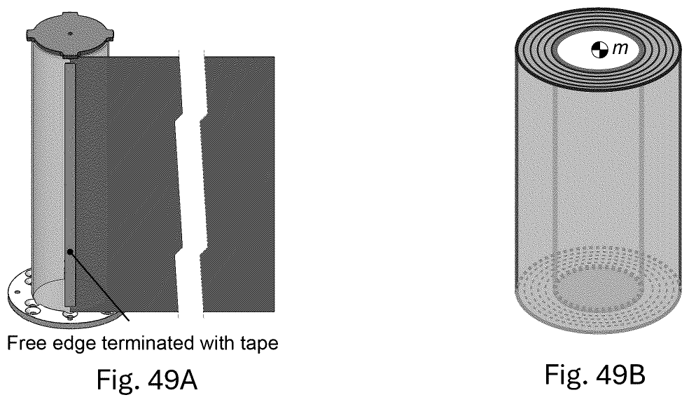

The reason for this discrepancy was previously theorized to be the result of the different boundary conditions. In the experiment, the longitudinal free edge of the innermost layer was fixed to the mandrel at the start of winding with tape (FIG. 49A). The extent of the constraint in the vertical direction, which is the dominant slip direction for this loading case, significantly limits the allowable movement of this layer. Conversely, both the theoretical and simulated models approximate the spiral wrap of the wound roll as a series of concentric shells, and each layer is restrained by the circular edge at the root (FIG. 49B). From the results depicted in FIG. 50, this boundary condition does not significantly restrict vertical slip, allowing the innermost layer to demonstrate the maximum slip magnitude.

This discrepancy in layer-wise location of maximum slip between simulation and experiments potentially indicates the sensitivity of this concept to the boundary conditions on each layer in the wound roll. However, in this particular configuration, the damping performance is not observed to be significantly affected, as there is good agreement between simulation and experiments in both transmissibilities and damping magnitudes, respectively. This further indicates that modeling a wound roll as a series of concentric cylinders is a good approximation, and additionally suggests that a damping device that consists of preloaded concentric cylindrical shells in frictional contact also constitutes a valid damper configuration.

The results of this study demonstrate that the simulation successfully captures the experimentally observed behaviors: the inner layers towards the bottom of the roll, in the axis of vibration, have the largest effect on dissipation for the wound roll damper concept due to slipping in the vertical direction.

The FEA model demonstrated good qualitative and quantitative agreement with experimental damping responses. The span of resonant peaks and corresponding damping variation with preload match those measured experimentally. The vibration response correlation between the FEA model and experimental results is noteworthy, particularly considering that only one slipping interface was modeled. This result reinforces the notion that the innermost layers are important regions of energy dissipation in this damping scheme.

Moreover, the slip investigation revealed slip extents and vectors consistent with experimental data and theoretical predictions. The results further confirm that slip propagates to additional layers and axial extents under larger excitation. This finding provides direct evidence of the self-scaling property inherent in this concept.

The identified underlying mechanism for wound roll damping is confirmed to result from the coupling between structural dynamics and interlayer contact properties. For a given loading, the locations of maximum shear stresses in the wound roll are seen at the base, near the mandrel interface. As a result, these are the locations where slip will initiate once the excitation level exceeds the force of friction.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to +0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A device for dynamic damping of vibrations comprising:
a plurality or layers disposed adjacently to define a plurality of layer interfaces, the plurality of layers configured to generate a friction force between the plurality of layer interfaces; and
a load force applied to the plurality of layers, across the plurality of layer interfaces and configured to permit an interlayer slip between the plurality of layers during a vibrational excitation, such that a vibrational excitation force applied to the device induces the interlayer slip and a frictional force thereby reducing the amount of the vibrational excitation;
wherein the plurality of layers form a concentric structure, and each of the plurality of layer interfaces is configured to have a coefficient of friction and to be disposed such that there are one or more points of contact between adjacent layer interfaces.

2. The device of claim 1, wherein the concentric structure is configured in a spiral geometry.

3. The device of claim 2, wherein a first layer with a first layer interface and a second layer interface is configured such that the first layer interface contacts the second layer interface.

4. The device of claim 2 further comprising a spindle element, and wherein at least one layer is coupled to the spindle element.

5. The device of claim 4, wherein a tension force is applied to the plurality of layers.

6. The device of claim 5, wherein the tension force applies a radial load to the concentric structure to generate an additional frictional force thereby adjusting the interlayer slip.

7. The device of claim 2, wherein the plurality of layers further comprise at least one sacrificial layer configured to abrade under the interlayer slip.

8. The device of claim 1, wherein a compositional discontinuity is disposed within at least one of the plurality of layers.

9. The device of claim 1, wherein at least one of the plurality of layers further comprises a void.

10. The device of claim 9, wherein the plurality of layers are disposed such that the plurality of interfaces are not contiguous.

11. The device of claim 1, wherein the at least one layer has a thickness that is nonuniform and such that there is intermittent contact between the layer interfaces of at least one layer adjacent thereto.

12. The device of claim 1, wherein the concentric structure has a resonant frequency, and wherein the preload force is configured based on the resonant frequency.

13. The device of claim 6, wherein the tension force is further configured to adjust the stiffness of the concentric structure.

14. The device of claim 1, wherein the plurality of layers are further configured to induce a propagation of the interlayer slip to additional layers under the vibrational excitation.

15. The device of claim 1, wherein the plurality of layers form concentric circles such that each layer has at least one layer interface in contact with at least one layer interface of an adjacent layer.

16. A method of dynamic vibration damping comprising:
providing a load force to tune a structure, wherein the structure comprises a plurality of concentric layers disposed adjacent to define a plurality of layer interfaces, the plurality of layers configured to allow interlayer slip therebetween and generate a frictional force between the plurality of layer interfaces,
inducing an interlayer slip between the plurality of layers via application of a vibrational excitation force to the structure such that a frictional force is further induced at the adjacent interfaces, thereby reducing the propagation of the excitation force,
wherein each of the plurality of layer interfaces is configured to have a coefficient of friction and is disposed such that there are one or more points of contact between adjacent layer interfaces, and wherein varying the load force provided alters the frictional force and the interlayer slip thereby varying at least one of the energy dissipation, stiffness, and damping properties of the structure.

17. The method of claim 16, wherein the damping and stiffness of the structure are further tunable by configuring the points of contact and the coefficient of friction, and where the interlayer slip only occurs across a partial region of at least one of the layer interfaces.

18. The method of claim 17, wherein the damping of the structure is further tunable by configuring the interlayer slip such that at a set vibrational excitation, the interlayer slip propagates across a set number of the plurality of layers.

19. The method of claim 16, wherein the structure has a resonant frequency, and wherein the load force is set based on the resonant frequency.

20. The method of claim 16, wherein the concentric layers form a spiral structure, and wherein a winding tension is applied to the spiral structure, thereby changing the frictional force in the structure and such that the damping of the structure is further tunable.

21. An energy absorbing structure comprising:
a structure defining a volume the structure comprising at least one multilayer element comprised of a plurality of concentric layers configured with adjacent interfaces wherein an excitation force applied to the structure induces an interlayer slip between the adjacent interfaces of the multilayer element;
wherein the adjacent interfaces are configured to generate a frictional force during the interlayer slip and thereby reduce the excitation force within the structure; and
wherein the frictional force is configurable by applying a selected preload force and a selected stress to the structure.

22. The structure of claim 21, wherein the damping and stiffness of the structure are further tunable by configuring the plurality of layer interfaces such that the interlayer slip only occurs across a partial region of the plurality of layer interfaces.

23. The structure of claim 21, wherein the structure is disposed within a vehicle, and the volume is configured to receive a payload.

24. A device for dynamic damping of vibrations comprising:
a concentrically wound layer configured to form a spiral structure and generate a set friction force between a plurality of layer interfaces; and a load force applied to the concentrically wound layer, across the plurality of layer interfaces and configured to permit an interfacial slip between the plurality of layer interfaces during a vibrational excitation, thereby inducing a frictional force therebetween reducing the amount of the vibrational excitation; wherein each of the plurality of layer interfaces are configured to have a coefficient of friction and are disposed such that there are one or more points of contact between each adjacent layer interface.

25. The device of claim 24 further comprising a spindle element, wherein the concentrically wound layer is coupled to the spindle element.

26. The device of claim 24, wherein a compositional discontinuity is disposed within the concentrically wound layer.

27. The device of claim 24, wherein the concentrically wound layer further comprises a void.

28. The device of claim 27, wherein the concentrically wound layer is disposed such that the plurality of interfaces are not contiguous.

29. The device of claim 24, wherein the concentrically wound layer has a thickness that is nonuniform and such that there is intermittent contact between the layer interfaces adjacent thereto.

30. The device of claim 24, wherein the spiral structure has a resonant frequency, and wherein the load force is set based on the resonant frequency.

31. The device of claim 24, wherein the concentrically wound layer is further configured to induce a propagation of the interfacial slip through the plurality of layer interfaces under the vibrational excitation.
